(19) United States
(12) Patent Application Publication
(10) Pub. No.: US 2025/0119785 A1
(43) Pub. Date: Apr. 10, 2025

(54) XR METHODS FOR SUPPORTING HIGH GRANULARITY QOS DIFFERENTIATION

(71) Applicant: InterDigital Patent Holdings, Inc., Wilmington, DE (US)

(72) Inventors: Jaya Rao, Montreal (CA); Senay Negusse, Montreal (CA); Tejaswinee Lutchoomun, Montreal (CA); Ananth Kini, Conshohocken, PA (US); Ahmed Mostafa, Ottawa (CA); Ghyslain Pelletier, Montreal (CA); Benoit Pelletier, Roxboro (CA)

(73) Assignee: InterDigital Patent Holdings, Inc., Wilmington, DE (US)

(21) Appl. No.: 18/835,961

(22) PCT Filed: Feb. 10, 2023
(86) PCT No.: PCT/US2023/062355

§ 371 Date: Aug. 5, 2024

Related U.S. Application Data
(60) Provisional application No. 63/309,193, filed on Feb. 11, 2022.
(60) Provisional application No. 63/335,293, filed on Apr. 27, 2022.
(60) Provisional application No. 63/395,547, filed on Aug. 5, 2022.
(60) Provisional application No. 63/410,755, filed on Sep. 28, 2022.

(51) Int. Cl. H04W 28/02

(52) U.S. Cl. CPC H04W 28/0236

(57) ABSTRACT

Systems, methods, and instrumentalities are disclosed herein for XR methods for supporting high-granularity QoS differentiation. A WTRU may receive a delay threshold associated with one or more PDU sets. The WTRU may determine PDU delay information associated with a PDU set, which may include a remaining amount of delay associated with a delay bound of the PDU set. The WTRU may select one or more logical channels for the PDU set. The WTRU may determine a logical channel prioritization (LCP) configuration associated with the selected logical channels based on the delay threshold and the PDU delay information, for example by comparing the PDU delay information to the delay threshold. The WTRU may transmit the PDU set using the determined LCP configuration. Transmitting the PDU set may include prioritizing one or more of the plurality of PDUs of the PDU set over PDUs of a higher-priority logical channel.

### CROSS-REFERENCE TO RELATED APPLICATIONS

This application claims the benefit of U.S. Provisional Patent Application No. 63/309,193, filed on Feb. 11, 2022, U.S. Provisional Patent Application No. 63/335,293, filed on Apr. 27, 2022, U.S. Provisional Patent Application No. 63/395,547, filed on Aug. 5, 2022, and U.S. Provisional Patent Application No. 63/410,755, filed on Sep. 28, 2022, the entire contents of which are incorporated herein by reference.

### BACKGROUND

The term “extended reality” (e.g., extended Reality or XR) is an umbrella term for different types of immersive experiences that may include, for example, Virtual Reality (VR), Augmented Reality (AR) and/or Mixed Reality (MR), and the realities interpolated among them. Virtual Reality (VR) is a rendered version of a delivered visual and audio scene. The rendering may be designed to mimic the visual (e.g., stereoscopic 3D) and audio sensory stimuli of the real world as naturally as possible to an observer or user as they move within the limits defined by the application. Augmented Reality (AR) is when a user is provided with additional information or artificially generated items or content overlaid upon their current environment. Mixed Reality (MR) is an advanced form of AR where some virtual elements are inserted into the physical scene with the intent to provide the illusion that these elements are part of the real scene. XR may include one or more real-and-virtual combined environments and human-machine interactions generated by computer technology and wearables.

The notion of immersion in the context of XR applications/services may refer to the sense of being surrounded by the virtual environment as well as providing the feeling of being physically and spatially located in the virtual environment. The levels of virtuality may range from partial sensory inputs to fully immersive multi-sensory inputs leading to a virtual reality, which may be practically indiscernible from actual reality.

XR devices may be associated with capabilities that offer various degrees of spatial tracking. XR devices may be equipped with various sensors to enable spatial tracking, for example monocular/stereo/depth cameras, radio beacons, GPS, inertial sensors, etc. Spatial tracking may be performed at different levels (e.g., 3 Degrees of Freedom (DoF) (e.g., rotational motion along X, Y and Z axis) or 6 DoF (e.g., rotational and/or translational motion along X, Y and Z axis)). Spatial tracking may result in an interaction to experience some form of virtual content. The user may act in and/or interact with the components within extended reality. For example, the actions and/or interactions may involve movements, gestures, eye tracking etc. Spatial tracking may be an important enabler for immersive XR experience. For example, some form of head and/or motion tracking may ensure that the simulated visual and audio components from the user perspective are updated to be consistent with user's movements. Imprecise and/or delayed spatial tracking may lead to sensation of discomfort and/or motion sickness for the user.

A wireless transmit/receive unit (WTRU) may correspond to any XR device/node which may come in variety of form factors. A WTRU (e.g., an XR WTRU) may include, but is not limited to, the following: Head Mounted Displays (HMD), optical see-through glasses and camera see-through HMDs for AR and MR, mobile devices with positional tracking and camera(s), wearables, etc. In addition to the above, several different types of XR WTRU may be envisioned based on XR device functions, for example as display, camera, sensors, sensor processing, wireless connectivity, XR/Media processing and power supply, to be provided by one or more devices, wearables, actuators, controllers and/or accessories. One or more device/nodes/WTRUs may be grouped into a collaborative XR group for supporting one or more XR applications/experience/services.

### SUMMARY

A wireless transmit/receive unit (WTRU) may map packet data units (PDUs) of application data units (ADUs) in different quality of service (QOS) flows to level 2 (L2) forwarding configurations. For example, the WTRU may perform mapping of PDus of an ADU in different QoS flows to forwarding configurations (e.g., DRBs and/or LCHs) based on buffer occupancy thresholds and/or application indications (e.g., importance values) in PDUs.

The WTRU may receive a configuration (e.g., in RRC) that comprises one or more forwarding configurations (e.g., DRBs and/or LCHs), each of which may be associated with one or more buffer occupancy threshold values. The WTRU may receive one or more PDUs belonging to an ADU in one or more associated QoS flows. The WTRU may determine an expected amount of data volume when mapping PDUs from a QoS flow to a first forwarding configuration. If the expected amount of data volume in the first forwarding configuration is greater than the associated buffer occupancy threshold, the WTRU may send an indication to the network (e.g., a medium access control (MAC) control element (CE)) on triggering of buffer overload event, receive an indication from the network for splitting the QoS flow and other AS layer status, determine a first set of PDUs and a second set of PDUs in the QoS flow based on application importance indications (e.g., spatial importance) in the PDUs and the network/AS-layer indication, send the first set of PDUs in a QoS flow to the first forwarding configuration, and send the second set of PDUs in a QoS flow to a second forwarding configuration. If the expected amount of data volume in the first forwarding configuration is not greater than the associated buffer occupancy threshold, the WTRU may send the PDUs in the QoS flow to the first forwarding configuration. The WTRU may send PDUs in forwarding configurations in uplink (UL) after receiving resource grants.

The WTRU may perform one or more methods for handling QoS surge events. The WTRU may switch between mapping configurations (e.g., from a mapping configuration that ensures meeting average QoS to another mapping configuration that ensures meeting surge QoS) for mapping PDUs from QoS flows to forwarding configurations based on detection of QoS surge events.

The WTRU may receive a configuration (e.g., in RRC) that comprises one or more mapping configurations that include a first mapping configuration (e.g., which may be activated) and a second mapping configuration (e.g., which may be deactivated), one or more forwarding configurations (e.g., DRBs and/or LCHs), each of which may be configured with parameters for achieving average QoS (e.g., an average data rate with a latency constraint), and/or a threshold associated with a maximum increase in QoS for the first mapping configuration. The WTRU may receive one or more PDUs belonging to an ADU in one or more associated QoS flows. The WTRU may apply the first mapping configuration for mapping PDUs from QoS flows to the forwarding configurations. If an event indication is received and/or detected (e.g., there is an expected QoS surge event for a time duration), the WTRU may determine an expected increase in QoS (e.g., an amount of QoS surge) based on QoS achievable using the first mapping configuration and information in the event indication. If the expected increase in QoS is greater than a threshold, the WTRU may send to the network (e.g., MAC CE) an indication to request activating the second mapping configuration and information on the event (e.g., the amount of QoS increase and the surge event duration, receive an activation indication for the second mapping configuration, send PDUs using the activated second mapping configuration to forwarding configurations for the surge event duration, and send PDUs using the first mapping configuration after the expiry of the surge event duration. If the expected increase in QoS is not greater than the threshold, the WTRU may send the PDUs using the first mapping configuration to the forwarding configuration. The WTRU may send PDUs in forwarding configurations in uplink (UL) after receiving resource grants.

The WTRU may perform one or more methods for supporting differentiated QoS with application awareness during data transmissions. The WTRU may send assistance/status information associated with XR/application awareness to the network. The WTRU may receive configuration/assistance information from the network for supporting differentiated QoS. The WTRU may detect and/or receive triggering events/conditions for supporting differentiated QoS at the WTRU. The WTRU may determine an association of PDUs to ADU based on explicit or implicit indications and/or parameters. The WTRU may perform mapping of PDUs associated with ADU in different QoS flows to forwarding configurations. The WTRU may switch between different mapping configurations for mapping PDUs of ADUs to forwarding configurations. The WTRU may determines forwarding configurations for transmitting PDUs of ADU while ensuring the ADU level latency requirement is met. The WTRU may determine to change the priority handling procedure/configuration for addressing a QoS event. The WTRU may change configuration parameters at PHY and MAC layers for transmitting PDUs/ADUs when detecting triggering events/conditions. The WTRU may be configured with one or more sublayers/entities at access stratum for handling delivery of PDUs at the granularity of a PDU set. For example, a PDU set may include one or more PDUs that are associated with a (e.g., one) unit of information generated at an application, and are subject to per-PDU set level quality of service (QOS). The WTRU may change CG/SPS configuration parameters and/or select a CG/SPS configuration for (re) aligning with data transmission/reception. The WTRU may be configured to handle different types of PDU sets. The WTRU may be configured with LCP restrictions for handling PDU sets. The WTRU may determine an LCP configuration to apply for supporting traffic attributes and QoS of PDU sets.

A WTRU may receive configuration information comprising a delay threshold associated with one or more PDU sets. Each of the one or more PDU sets may include a plurality of PDUs The WTRU may determine PDU delay information associated with a PDU set of the one or more PDU sets. The PDU delay information may include an amount of delay (e.g., a remaining amount of delay) associated with a delay bound of the PDU set. The WTRU may select one or more logical channels for the PDU set. The WTRU may determine a logical channel prioritization (LCP) configuration associated with the selected logical channels based on the delay threshold and the PDU delay information. For example, the LCP configuration may include a logical channel restriction for the logical channels associated with the PDU set. Alternatively, the LCP configuration may include one or more LCP parameters for at least one logical channel, and the one or more LCP parameters may include a prioritization of the plurality of PDUs of the PDU set over one or more PDUs of a second PDU set. The WTRU may transmit the PDU set using the determined LCP configuration.

The WTRU may determine the LCP configuration by comparing the PDU delay information to the delay threshold. For example, the WTRU may select a first LCP configuration as the LCP configuration if the delay information is less than or equal to the delay threshold and a second LCP configuration if the delay information is greater than the delay threshold. Transmitting the PDU set using the first LCP configuration may include prioritizing one or more of the plurality of PDUs of the PDU set over PDUs of a higher-priority logical channel and transmitting the prioritized plurality of PDUs of the PDU set. Transmitting the PDU set using the first LCP configuration may include prioritizing PDUs of one or more logical channels based on a decreasing order of priority associated with the logical channels. The WTRU may transmit an indication of the PDU delay information to a network. The WTRU may map the plurality of PDUs to one or more logical channels.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of mapping PDUs associated with an ADU in different QoS flows to forwarding configurations.

FIG. 3 illustrates an example of a WTRU determining an LCP configuration to apply for supporting traffic attributes and QoS of PDU sets.

### EXAMPLE NETWORKS FOR IMPLEMENTATION OF THE INVENTION

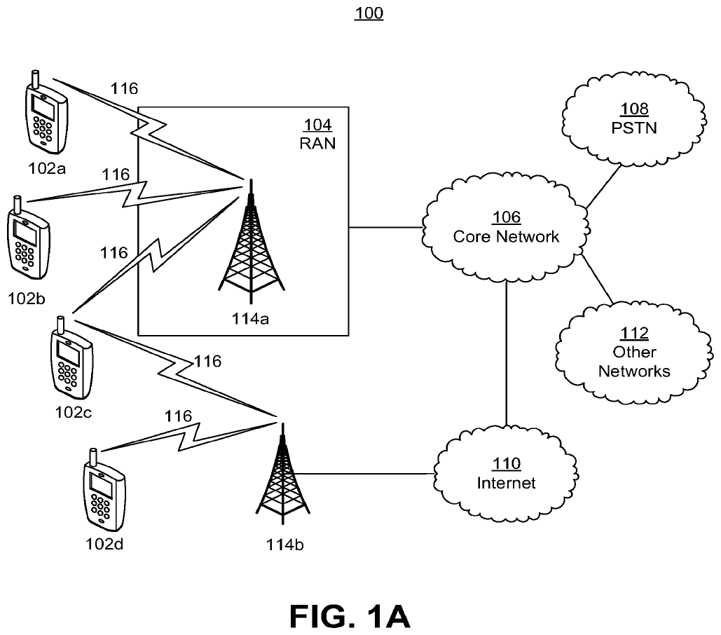

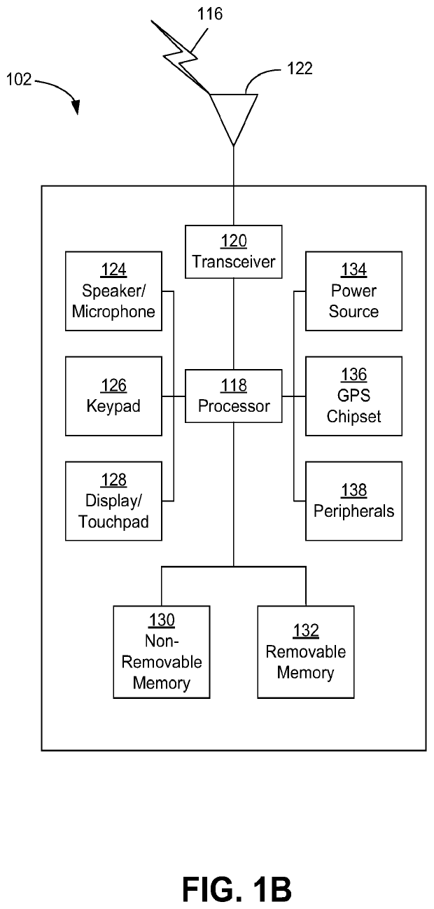

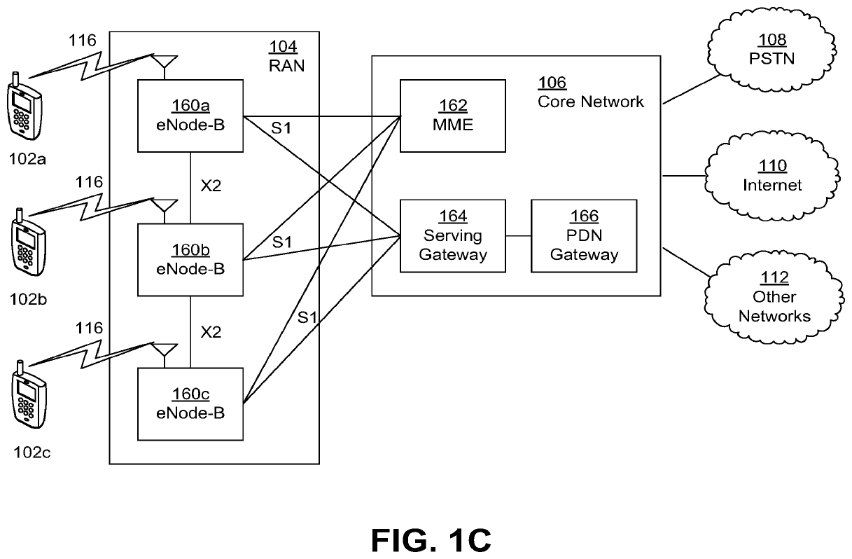

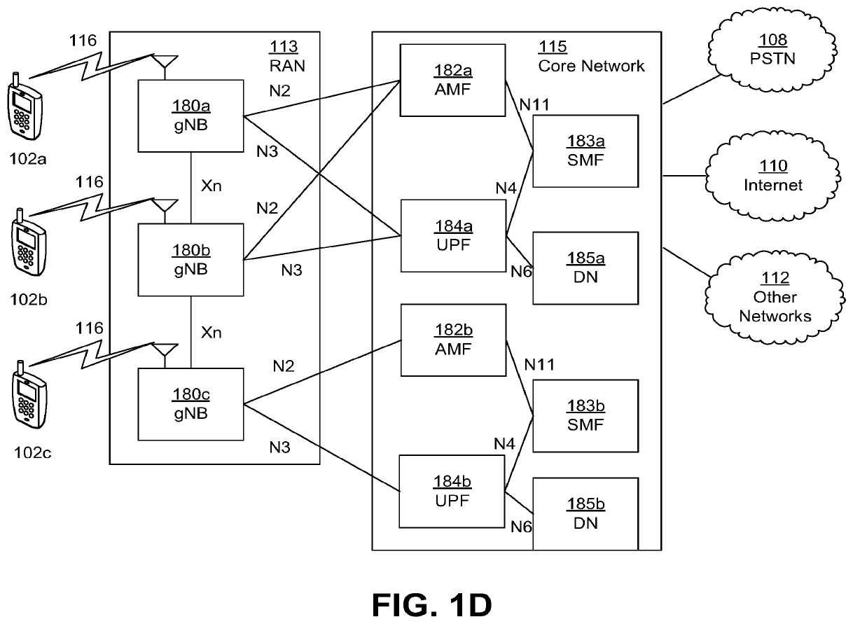

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHZ channel may be formed by combining 8 contiguous 20 MHz channels, or by combining two non-contiguous 80 MHZ channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

There may be different types of extended reality (XR) applications/use cases. Virtual reality 1 (VR1) applications may be used. VR1 applications (e.g., streaming of immersive 6 degrees of freedom (6DoF) may be modeled using service flows applicable for viewport dependent streaming architecture. Similar to adaptive streaming (e.g., DASH), viewport dependent streaming may allow for dynamically updating the quality of media/video based on the available bitrate in the network and wireless interface. As per the service/traffic flow, the tracking and pose information (e.g., small packet size: <100B) of the XR device's viewport is sent periodically with a relatively low data rate (e.g., 0.5-2 Mbps, 60 to 500 Hz) in uplink (UL) to the XR server. In response, the XR server sends in downlink (DL) with high data rate (e.g., 6-18 MBps for 4 k omnidirectional and field of view (FoV) area streaming) and quasi-periodically (e.g., 40/60/120 fps) the viewport-optimized media adaptively (e.g., H.264/265 video), which is then rendered in the XR device display.

The traffic characteristics of VR1 may be the following. UL traffic may include pose/viewport information (e.g., including information on 6DoF), and may have a small packet size (e.g., constant size <100B), a low data rate (e.g., 0.5-2 Mbps), and may be single-flow. UL traffic may be periodic (e.g., with a periodicity range of 60 to 500 Hz). DL traffic may include media/video containing a viewport-optimized scene (e.g., high quality) and/or media video for non-viewport scenes (e.g., lower quality), and may have a large packet size (e.g., variable size with Gaussian distribution or fixed size of 1500B), a high data rate (e.g., 6-18 Mbps) and end-to-end (E2E) latency (e.g., 50 ms), and may be multi-flow (e.g., may include video flows with different bit-rates, 3D media, and/or metadata). The DL traffic may be quasi-periodic (e.g., periodicity as a function of frame rate of 40/60/120 fps).

Virtual reality 2 (VR2) applications may be used. VR2 applications (e.g., immersive game spectator mode) may be modeled using service flows which are applicable to the split rendering architecture. The XR server may perform pre-rendering and encoding of the 2D media/video frame based on pose information sent by the XR device periodically at a low data rate (e.g., 0.5-2 Mbps, 60-500 Hz). The rendering is mainly performed in an XR server and sent in DL at high data rate and low latency (e.g., 30-45 Mbps, 10-20 ms). The XR device decompresses the received media/video and performs asynchronous time-warping (ATW) for correcting the viewport based on latest pose information. While RTT latency for transmission of pose info in UL and reception of pre-rendered media in DL may span up to 50 ms, ATW may enable satisfying the motion-to-photon latency requirement (<20 ms) based on in-device processing.

The traffic characteristics of VR2 may be the following. UL traffic may include pose/viewport information and may have a small packet size (e.g., constant size <100B), a low data rate (e.g., 0.5-2 Mbps), and may be single-flow. UL traffic may be periodic (e.g., with a periodicity range of 60 to 500 Hz). DL traffic may include 3D scenes in frame buffers, and may have a large packet size (e.g., variable size with Gaussian distribution or fixed size of 1500B or higher), a high data rate (e.g., 30-45 Mbps), a latency round-trip time of 30 ms or 50 ms, and may be multi-flow (e.g., may include 3D video/media and/or metadata). The DL traffic may be quasi-periodic (e.g., periodicity as a function of frame rate of 60/90 fps). Augmented reality 1 (AR1) applications may be used. AR1 applications (e.g., real-time communication with shop assistant) may be characterized using service flows applicable to distributed computing architecture. As per the service/traffic flow, the XR device sends the pose information (e.g., 0.5-2 Mbps, 60-500 Hz) and/or video (e.g., 10 Mbps, 10 Hz frame update rate) in UL to the XR server. The received information is used by the XR server to generate the scene, which is then converted a 2D (e.g., video) or 3D media (e.g., 3D objects) format along with metadata (e.g., scene description). The compressed media and metadata (e.g., which may be characterized by a Pareto distribution) are delivered quasi-periodically in DL at a relatively high data rate (e.g., 30-45 Mbps, 40/60/120 fps). The XR device then generates the AR scene locally, by overlaying 3D objects on 2D video, and renders the scene in the device display.

The traffic characteristics of AR1 may be the following. UL traffic may include pose information and/or 2D video stream information. Pose information may have a small packet size (e.g., constant size <100B), a low data rate (e.g., 0.5-2 Mbps), and may be periodic at 60 to 500 Hz. Video information may have a relatively large packet size, a data rate of 10 Mbps, may be periodic with an update periodicity of 10 Hz, and may be multi-flow video. DL traffic may include 2D/3D pre-rendered media and XR metadata, and may have a large packet size (e.g., Pareto distribution) and a high data rate (e.g., 30-45 Mbps), and may be multi-flow (e.g., may include 2D/3D media and/or metadata). The DL traffic may be quasi-periodic (e.g., periodicity as a function of frame rate of 60/90 fps). Augmented reality 2 (AR2) applications may be used. AR2 applications (e.g., XR meetings, AR animated avatar calls) may use service/traffic flows applicable for XR conversational architecture where two or more XR clients/device may perform peer-to-peer communications with intermediary media processing in a network. The different types of media that may be supported for AR2 applications, based on the type of user representation, may include 2D+/RGBD (e.g., at 2.7 Mbps), 3D mesh (e.g., at 30 Mbps) and/or 3D Video point cloud coding (VPCC)/Geometry-based point cloud compression (GPCC) (e.g., at 5-50 Mbps). An XR client in the device may initiate a call setup procedure, based on which a session control function triggers network-based media processing. The session control function also forwards the call setup to the second XR client/device followed by real-time media processing and streaming with low latency (e.g., E2E <100 ms) to both clients. During an XR call, the 2D/3D media, and possibly the user pose information, is transmitted quasi-periodically in UL and DL between the XR clients/devices.

The traffic characteristics of AR2 may be the following. UL traffic may include 2D/3D media, and a pose and/or video of a user. The UL traffic may have a relatively large packet size, a data rate of 2.7-50 Mbps, a packet delay budget (PDB)<150 ms, and may be multi-flow (e.g., 2D/3D media). UL traffic may be quasi-periodic (e.g., 60 to 500 Hz). DL traffic may include 2D/3D media and a pose and/or video of a user. DL traffic may have a large packet size (e.g., truncated Gaussian distribution), a data rate of 2.7-50 Mbps, and an E2E PDB of <100 ms, and may be multi-flow (e.g., may include 2D/3D media). The DL traffic may be quasi-periodic (e.g., 60 to 500 Hz).

XR Conferencing applications may be used. XR Conferencing applications may provide an immersive conferencing experience between geographically remote users by representing the users in a 3D volumetric representation (e.g., point clouds or meshes). One or more cameras (e.g., with depth perception capability) may be placed at each users' location to allow interactions (e.g., view, hear, rotate, zoom-in, resize) with a full 3D volumetric representation of one another on their respective headsets/glasses. XR Conferencing applications may support simultaneous UL and DL media traffic, with media consisting of audio, video and 3D objects. The media formats that may be applied to capture the user in 3D volumetric format include 2D+/RGBD (e.g., at >2.7 Mbps for 1 camera, >5.4 Mbps for 2 cameras), 3D Mesh (e.g., at ˜30 Mbps) and 3D VPCC/GPCC (e.g., at 5-50 Mbps). The media processor may be located centrally or distributed the edge. Additionally, the service/traffic flow between the XR clients/users via the in-network media processor is expected to be similar to the AR2 and XR conversational use cases. Joining an XR conference session may result in a download peak at the beginning for downloading the virtual environment and associated media objects within the XR application. Throughout the rest of the session, data rates may vary depending on, for example, a number of users, an upload format of the users, and/or refresh rates of the virtual 2D/3D objects/environment.

The traffic characteristics of XR conferencing may be the following. UL traffic may include 2D/3D media, and a pose and/or real-time video of a user. The UL traffic may have a relatively large packet size, a data rate of 2.7-50 Mbps, and may be multi-flow (e.g., 2D/3D media). UL traffic may be quasi-periodic (e.g., 60 to 500 Hz). UL traffic may have a low encoder packet error rate (PER) of <10⁻³. DL traffic may include 2D/3D media, a pose and/or real-time video of a user, and 2D/3D objects/environment (e.g., which may be from a third party). DL traffic may have a large packet size, a data rate of 2.7-50 Mbps, and an E2E PDB of <100 ms, and may be multi-flow (e.g., may include 2D/3D media). The DL traffic may be quasi-periodic (e.g., 60 to 500 Hz) and may have a low encoder PER of <10⁻³.

Cloud Gaming (CG) applications may be used. CG applications (e.g., 5G online gaming) may predominantly rely on an adaptive streaming architecture, where the rendered video/media in network is streamed to a thin client in the device (e.g., smartphone, tablet, etc.). In a typical service/traffic flow for CG, the XR device sends the pose information (e.g., 100 to 250B) related to viewport periodically in UL (e.g., at 0.1-1 Mbps, 60-500 Hz) to the XR server. The generated viewport-related video/media (e.g., 1500B) is encoded/compressed (e.g., H.264/265 video) and sent quasi-periodically by the XR server in DL (e.g., 30-45 Mbps, 30/50/60/90/120 fps, PER: 10⁻³). The received video/media is then rendered in the XR device upon decoding and processing. The RTT latency for supporting certain high-end CG applications (e.g., Category D: photo-realistic or natural video games) may be determined by the roundtrip interaction delay (e.g., 50 ms). For other CG applications (e.g., Category A, B, C), the uplink PDB may be 10 ms, and downlink streaming PDB may range from 50 ms to 200 ms.

The traffic characteristics of CG may be the following. UL traffic may include pose/viewport information. The UL traffic may have a relatively small packet size (e.g., 100 to 250B), a low data rate of 0.1-1 Mbps, a PDB of 10 ms, and may be single flow. UL traffic may be periodic (e.g., 60 to 500 Hz). DL traffic may include 2D/3D media and/or a video of the user. DL traffic may have a large packet size (e.g., max 1500B), a high data rate of 30-45 Mbps, and a PDB of 20 ms, and may be multi-flow (e.g., may include 2D/3D media and/or video). The DL traffic may be quasi-periodic (e.g., periodicity as a function of frame rate of 30/50/60/90/120 fps) and may have a low encoder PER of <10⁻³.

In the existing NR quality of service (QOS) framework, the QoS may be differentiated at the granularity of per-flow, where each QoS flow may be identified with a QoS flow identifier (QFI). A QFI may be associated with a number of QoS parameters such as traffic type (e.g., Non-GBR/GBR/Delay-critical GBR), data rate (e.g., GFBR/MFBR), packet delay budget, averaging window, maximum data burst volume (MDBV), survival time, etc. Such QoS parameters may be applied for providing a consistent forwarding treatment during transmission to the PDUs in the QoS flow. However, such QoS framework and QoS parameters may not be directly applicable for handling the traffic associated with XR services.

In XR services and applications such as AR, VR, and CG, the traffic may consist of data/PDUs which may be associated with a media frame or application data unit (ADU). The PDUs belonging to an ADU may be associated with different spatial positions in the frame. For example, a number of PDUs in an ADU may carry data associated with field of view (FoV) spatial positions in the frame. Likewise, the other PDUs in the ADU may carry non-FoV spatial positions in the frame. The different PDUs in an ADU may contribute to different user experience and as such, may be associated with different spatial and/or temporal importance values. PDUs associated with an ADU may need to be differentiated and handled differently QoS-wise, irrespective of whether the PDUs of ADU are in one or more associated QoS flows, during transmissions (e.g., unlike the existing QoS framework where all PDUs in a QoS flow are provided with the same forwarding treatment).

Inter-dependencies between the PDUs of an ADU in a single or multiple QoS flows may result in different challenges for ensuring the relative QoS associated with the PDUs (e.g., maximum difference in QoS achievable for different PDUs of an ADU) is met, in addition to meeting the absolute QoS requirement of the individual PDUs, during transmission in UL and DL. Additionally, due to certain events (e.g., change in user movement, change in scene, etc.), the amount of critical/high importance PDUs in an ADU which need to be transmitted with high data rate and very low latency may surge over a relatively short time window. In such instances, using semi-static configuration at the access stratum (AS) layers for handling the sudden surge in high importance PDUs, lack of queue management mechanism in L2 for ensuring bounded latency and handling dynamically changing inter-dependencies between PDUs in an ADU may be challenging. Thus, ensuring QoS requirements of data/QoS flows associated with XR services may include preserving inter-dependencies between PDUs in an ADU, satisfying the ADU-level QoS during transmissions, handling surges in traffic/QoS, and/or accounting for dynamically changing inter-dependencies and relative importance of PDUs in an ADU.

QOS handling for XR may be performed.

As used herein, the term “network” may include any of a base station (e.g., a gNB, TRP, RAN node, access node), a core network function (e.g., AMF), and/or an application function (e.g., edge server function, remote server function), for example.

As used herein, the term “flow” or “flows” may correspond to any of: QoS flows or data flows (e.g., flow(s) of data consisting of one or more PDUs or ADUs, which may be associated with one or more QoS requirements, such as latency, data rate, and/or reliability). Different flows, possibly originating from a common application/experience source and/or intended to a common destination device/wireless transmit receive unit (WTRU) or group of associated devices/WTRUs, may be referred to associated flows or correlated flows.

As used herein, the term “forwarding configuration” may correspond to any of the following: radio bearers (e.g., data radio bearers (DRBs) and/or signaling radio bearers (SRBs)), logical channels (LCHs), logical channel groups (LCGs), configuration parameters in the individual layers within the AS protocol stack (e.g., service data adaptation protocol (SDAP), packet data convergence protocol (PDCP), radio link control (RLC), medium access control (MAC), physical layer (PHY), or other protocol layers), parameters associated with logical channel prioritization (LCP) (e.g., priority, PBR, BSD), BWPs, carriers, radio links/interfaces (e.g., Uu links, SLs), and/or radio resources (e.g., a set of one or more frequency/time/spatial resources such as timeslots, subcarriers, or beams). Radio resources may also be associated with configurated grants, dynamic grants and/or any other resource grants or grant free resources.

As used herein, the term “mapping configuration” may correspond to any of the following: parameters and/or configurations associated with mapping from one or more application data (e.g., ADU) flows, QoS flows (e.g., associated or non-associated), or one or more radio bearers, SDAP, PDCP, LCHs, carriers or component carriers (e.g., CCs in CA configurations), BWPs, and radio links/interfaces (e.g., Uu link or sidelinks), which may be used for delivering the PDUs in UL direction or DL direction, for example.

As used herein, the term “collaborative devices/WTRUs” or “associated devices/WTRUs), which may be collectively associated for supporting an application/experience, may correspond to any of the following: independent/stand-alone WTRUs/devices/nodes (e.g., XR device, XR glasses, smart watches), which may be possibly configured with direct connectivity to a network via one or more links (e.g., Uu links); non stand-alone devices/nodes (e.g., devices associated with a WTRU, sensors, wearable devices, haptics gloves, reference nodes/WTRUs), which may not be configured with direct connectivity to network but may be accessible to/by a network via one or more indirect links (e.g., SL or via another WTRU with direct connectivity); devices/nodes controlled by the network (e.g., a network operator); and/or stationary/static or moving/mobile devices/nodes/WTRUs.

As used herein, the terms “XR/application-aware data transmissions/receptions” or “XR/application-aware QoS handling” may correspond to any of the following: ADU handling; application/high layer importance/priority; and/or QoS flow handling.

In ADU handling, an ADU (e.g., media unit, video frame) may comprise one or more PDUs. An ADU may be associated with ADU-level QoS requirements (e.g., data rate, latency, reliability), which may be applicable for one or more or PDUs associated with an ADU. The different PDUs in an ADU may be associated with individual PDU-level QoS requirements. Such associations and inter-dependencies may be visible to the AS-layers (e.g., with associated IDs) and/or handled at the AS layers with the awareness of the association during data transmission and reception.

In application/high layer importance/priority, the different PDUs in an ADU (e.g., or all PDUs in an ADU) may be associated with different application/high layer importance/priority values. Such importance value may correspond to spatial importance (e.g., spatial position of the video frame whose data is carried by the PDU/ADU, where PDUs/ADUs carrying FoV spatial positions may be associated with higher spatial importance than non-FoV spatial positions) or temporal importance (e.g., time sequence of the video frame who data is carried by the PDU/ADU, where PDUs/ADUs carrying base video frames such as I-frame may be associated with higher temporal importance than differential video frames such as P-frame/B-frame). Such importance values may be visible to the AS layers (e.g., with associated IDs/markers/indications), possibly enabled by application awareness, during data transmission and reception.

In QoS flow handling, the ADUs/PDUs of an application may be encoded and/or delivered by the application to the WTRU (e.g., in UL) or the network (e.g., in DL) via one or more QoS/data flows. In this regard, the different QoS flows carrying the ADUs/PDUs associated to an XR application/experience may be visible to the AS-layers (e.g., with associated IDs) and/or handled at the AS layers with the awareness of the association during data transmission and reception.

As used herein, the term “WTRU action(s),” which may be related to application actions and/or AS-layer actions for ensuring/supporting differentiated QoS, may correspond to any of the following: determining the metadata of an application (e.g., an XR application); determining/generation of application content; performing measurements and/or reporting; handling/forwarding of data/PDUs/ADUs and handling QoS associated with PDUs/ADUs; handling/forwarding of information related to connectivity with network and/or other WTRUs; and/or the like.

WTRU action(s) may include determining the metadata of an application (e.g., an XR application). Determining metadata of an application may involve determining any of the FoV/visual perimeters, 2D/3D size, border, spatial attributes, and/or boundaries of FoV, for example based on measurements in any spatial dimension(s), including but not limited to longitude, latitude, altitude, depth, roll, pitch, yaw in one more coordinate systems (e.g., cartesian, spherical). For example, determining metadata may involve determining the quality of the FoV content (e.g., whether the FoV content is of high quality, which, in the case of an image, may be quantified and assessed by the image resolution (e.g., number or density of megapixels)). Determining metadata may involve determining the importance and/or priority of the FoV content. The importance may be associated with the spatial importance and/or temporal importance of content/data. For example, the spatial/temporal importance value may indicate the absolute and/or relative importance associated with the FoV content. Spatial importance may be associated with one or more segments/tiles/slices/positions of FoV in a spatial dimension, for example. Temporal importance may be associated with one or more frames/subframes of FoV in time dimension, for example.

WTRU actions may include determining/generation of application content. Determining/generation of application content may involve determining/capturing the one or more 2D/3D images/video frames associated with an FoV boundary/perimeter/border as defined by the FoV metadata by the WTRU/node for itself and/or on behalf of another WTRU/node. For FoV content mapping, the WTRU may determine the images/video frames using visual sensors (e.g., 2D/3D camera, lidar), RF sensors (e.g., RF transceiver, RADAR), audio sensors (e.g., sonar), etc. Herein, the mapping of FoV may also be referred to as sensing of FoV content or capturing of FoV content. Determining/generation of application content may also include recording/capturing of audio frames, either as part of the real environment or as part of an overlaid sound-track/audio file with the audio file originating from a source other than the current real environment being mapped.

WTRU actions may include performing measurements and/or reporting. The WTRU may perform measurements of pose (e.g., 6DoD/3DoD orientation, location/position), rate of motion/movement, etc. of the user/WTRU and/or other objects (e.g., virtual or real) which the user may be interacting with. The WTRU may send/report the pose measurements to a network, for example periodically or when detecting event triggers (e.g., change in pose measurements above/below a threshold). In an example, the WTRU may perform measurements of one or more of reference signals (e.g., SSB, CSI-SR, PRS, sidelink RS), GNSS signals, unlicensed carriers, ultra-wideband signals, LIDAR signals, visual signals, etc. In another example, the WTRU may perform measurements of the radio link interface(s) associated with the WTRU (e.g., Uu link, SL). The WTRU may trigger transmission and/or measurement of reference signals in one or more other WTRUs (e.g., via Uu link and/or sidelink). The WTRU may send a measurement report to the network and/or to another WTRU.

WTRU actions may include handling/forwarding of data/PDUs/ADUs and handling QoS associated with PDUs/ADUs. The data may include any of media/image/video frames, sensor data, and/or measurement data (e.g., pose measurements, link/channel measurements) determined by the WTRU, possibly for supporting an application/service/network request associated with the WTRU. The WTRU may send and/or receive data to/from one more destinations, including a RAN node (e.g., gNB), CN function/entity, application function (e.g., hosted in the WTRU or in network), and/or the like. The WTRU may perform splitting/merging of data/PDUs in one or more Qos flows into one or more forwarding configurations during transmissions/reception.

WTRU actions may include handling/forwarding of information related to connectivity with a network and/or other WTRUs. For example, handling/forwarding of information related to connectivity with the network and/or other WTRUs may include sending capability information to the network, including information regarding a capability for supporting one or more interfaces and/or information regarding a capability to coordinate and/or interact with other WTRUs/devices (e.g., via SL interfaces), which may be co-located or non co-located with the WTRU; receiving configuration(s), including receiving RRC configuration(s) from a gNB and/or a NAS-layer configuration from a CN; sending and/or receiving assistance data to/from network associated with traffic, QoS, scheduling, etc., for supporting UL/DL transmission; and/or sending requests for radio resources and/or resource grants (e.g., dynamic grants, semi-static/configured grants).

A WTRU may support differentiated QoS. In examples, a WTRU may be configured for flexibly updating the mapping configurations, forwarding configurations, the protocol stack including SDAP, PDCP, RLC, MAC, PHY and/or any other layers in the AS layers, based on the detection of one or more configured triggering conditions.

The ADUs and/or PDUs received in one or more QoS flows, with the same or different QoS requirements, may be mapped to one or more forwarding configurations using mapping configurations. The different forwarding configurations may be configured to achieve/enforce different QoS when transmitting the ADUs/PDUs. In an example, the PDUs of an ADU received in one or more QoS flows may be mapped using a mapping configuration (e.g., at SDAP) to one or more forwarding configurations (e.g., DRBs with common/different PDCP entities), where the forwarding configurations may be associated/grouped for achieving/ensuring ADU-level QoS. Upon mapping, the configuration (e.g., priority, PDB) at the forwarding configurations for achieving/enforcing PDFU-level and/or ADU-level QoS may be applied to the PDUs/ADUs in the buffers associated with the forwarding configuration.

The PDUs of different ADUs to be received in different QoS flows may have different expected QoS to be satisfied during transmission. Based on the determination of the expected QoS for the PDUs/ADUs received or to be received in QoS flows, the WTRU may apply certain mapping and buffer/queue management mechanisms at one or more layers of the AS layer protocol stack (e.g., SDAP, PDCP, MAC) such that the expected QoS for the PDUs may be satisfied during transmission and/or upon reception at network.

For satisfying the QoS requirements of PDUs/ADUs, the different layers in the forwarding configuration may be configured with different configuration parameters. Such configuration parameters may include support for AM/UM in RLC, LCP rules/restrictions and associated LCH parameters (e.g., PBR, BSD, priority) at MAC, and/or a number of HARQ transmissions, for example. For satisfying QoS requirements, certain parameters may be configured in the PDCP (e.g., sequence number size, ROCH) and/or SDAP (e.g., mapping between QFI and radio bearers) sublayers, for example.

The term “expected QoS,” as used herein, may denote the expected margin of a certain QoS metric (e.g., latency, data rate, reliability) before the arrival of the PDUs/ADUs or when the PDUs/ADUs are received at the WTRU (e.g., the QoS to be achieved/enforced when transmitting). In an example, the expected QoS may correspond to a time duration available at the WTRU for forwarding PDUs on Uu link. The expected QoS may also correspond to the time-to-live (TTL) (e.g., maximum time available for processing and delivering) for an individual PDU or different PDUs in an ADU, for example. The expected QoS may be determined based on the indications/markers in the PDUs (e.g., QFI, timestamps, ADU ID, etc., in the PDU header) and/or based on usage of timers which may be set when receiving the PDUs/ADUs and reset/stopped at the expiry of a configured time duration, for example. Similar mechanisms (e.g., based on indications/markers and/or timers) may be applied for changing between different mapping and/or forwarding configurations for ensuring expected QoS.

In some examples, the expected QoS/TTL may be stricter or more relaxed than the default QoS metric applied associated with the PDUs/ADUs. For example, if a PDU arrives late at the WTRU or the importance value for the PDU is indicated to be high (e.g., above a threshold), having experienced more delay and jitter at the application layer (e.g., due to encoder), the expected latency to be satisfied over the Uu link for the PDU may be lower than the default PDB that is typically used for sending the PDU. Alternatively, if a PDU arrives early or the importance value for the PDU is indicated to be low (e.g., below a threshold), the expected latency over the Uu link may be considered to be more relaxed than the PDB that is normally used for sending such PDUs.

The expected QoS may vary dynamically based on the QoS experienced during reception and/or importance/priority indications, where for a fixed QoS (e.g., PBR, PDB) an increase/decrease in the expected QoS prior to reception may translate to a decrease/increase in the expected QoS over the Uu link.

In examples, a WTRU may be configured to perform 1:1, N:1 or N:M mapping from one or more QoS flows to one or more forwarding configurations for enabling flexible utilization of radio bearers and resources while satisfying the QoS of the PDUs/ADUs.

Differentiated QoS with application awareness during data transmissions may be supported. In examples, the WTRU may support differentiated QoS, with one or more levels of QoS granularities, when handling data transmissions associated with ADUs. The WTRU may support differentiated QoS and/or assist the network for supporting differentiated QoS during data transmissions based on one or more of the following: configurations, triggering events, conditions/criteria received from network and/or application(s).

The WTRU may be configured with one or more conditions and/or configurations associated with the treatment/handling of data/PDUs associated with ADUs to be transmitted to a network or received from the network. Such conditions and/or configurations may be related to, or may reflect, an expected QoS to be achieved for the data/PDUs/ADUs during transmission to the network (e.g., in UL) or reception at the WTRU (e.g., in DL), or a change of such expected QoS.

The WTRU may support differentiated QoS when operating in WTRU-based and/or WTRU-assisted modes associated with handling the traffic/QoS of during data transmissions. The different modes for WTRU operation when supporting differentiated QoS may include WTRU-based differentiated QoS and/or WTRU-assisted differentiated QoS. In WTRU-based differentiated QoS, the WTRU may perform selection/determination of one or more configurations/parameters/mechanisms for satisfying QoS requirements associated with XR/application-aware data transmission/reception, based on assistance information and/or configuration information received from the network. In WTRU-assisted differentiated QoS, the WTRU may assist the network for selection/determination of one or more configurations/parameters/mechanisms for satisfying QoS requirements associated with XR/application aware data transmissions/reception, by providing assistance information and/or preferred configuration information (e.g., preferred parameters to be supported in mapping/forwarding configurations) to the network.

A WTRU, based on one or more conditions/configurations/operation modes described herein, may perform mapping of PDUs of an ADU in different QoS flows to one or more forwarding configurations, and/or determining/selecting a set of forwarding configurations and/or parameters of forwarding configurations for transmitting PDUs of an ADU.

In examples (e.g., as described herein), the WTRU may perform mapping of PDUs of an ADU in different QoS flows to one or more forwarding configurations. Such mapping may be performed based on usage of one or more configured mapping configurations (e.g., determining mapping configuration parameters, dynamic activation/deactivation, etc.) and other conditions/configurations described herein. This type of mapping may be referred to herein as “mapping of PDUs of ADU to forwarding configurations at WTRU for supporting differentiated QoS.”

In examples (e.g., as described herein), the WTRU may determine/select a set of forwarding configurations and/or parameters of forwarding configurations for transmitting PDUs of an ADU. Such determination/selection may be performed based on usage of one or more configured forwarding configurations, associated parameters, and/or other conditions/configurations described herein. This may be referred to herein as “determining/selecting forwarding configuration at WTRU for supporting differentiated QoS.”

The WTRU may send assistance/status information associated with XR/application awareness to the network. In examples, the WTRU may send information associated with supporting XR/application-awareness and/or QoS handling (e.g., association of PDUs to ADU) to the network, possibly for enabling the network to have awareness of the WTRU actions and/or application/QoS configurations/parameters supported by the WTRU.

The information associated with XR/application awareness and/or QoS may be sent from the WTRU to the network as one or more of the following message types: assistance information; preferred configuration information (e.g., preferred mapping and/or forwarding configurations/parameters to apply in UL/DL); status information/indication (e.g., associated with any of the AS-layers); measurement/status reports (e.g., WTRU pose info, channel/link measurements, buffer occupancy measurements); and/or request/response messages.

The information may be sent by the WTRU periodically (e.g., using one or more configured periodicity values), aperiodically/dynamically (e.g., when detecting triggering events/conditions described herein), as an update message (e.g., when detecting a change in information sent previously) and/or on a semi-persistent basis (e.g., sent with a periodicity value over a time window/duration). In an example, the WTRU may switch between a first periodicity value and a second periodicity value for sending information, possibly based on the type of event detected (e.g., a QoS surge event). In another example, the WTRU may change between sending information periodically and aperiodically based on whether any change and/or amount of change is determined in the information sent/reported.

The WTRU may send the information/indications to network via one or more of the following: RRC signaling and/or messages; control PDUs associated with any of the AS layers (e.g., SDAP control PDU, PDCP control PDU, etc.); a UL MAC CE (e.g., BSR, pre-emptive BSR, elastic BSR which may be scalable/adjustable by sending subsequent indications, possibly without cancelling an earlier BSR, etc.); UCI (e.g., SR, feedback, ACK/NACK, CSI, etc.); non-AS (NAS) layer signaling (e.g., PDU session related messages); and/or application layer signaling/messages.

The information sent by the WTRU to the network, in any of the message types, may include a combination of one or more of the following: identifiers/IDs; priority of applications supported by the WTRU; data flows associated with the application; devices associated with the application; data/traffic types associated with the data flows per application; traffic characteristics and/or parameters of data/traffic associated with the data/QoS flows per application; QoS requirements or expected QoS associated with the data; pose information (e.g., orientation, position/location); capability information associated with connectivity; capability information associated with WTRU actions; preferred configuration information; indication(s) for activating/deactivating configurations; measurements related to the application/AS layer; and/or uncertainty information.

The information sent by the WTRU to the network, in any of the message types, may include one or more identifiers/IDs. For example, the WTRU may send one or more IDs, including one or more of the following: ID(s) associated with application (e.g., application ID, service ID, session ID, application configuration ID, etc.); a group ID (e.g., associated with a group of QoS flows, a group of forwarding configurations, and/or a group of devices/WTRUs); ID(s) of individual QoS flows, mapping configurations, and/or forwarding configurations; and/or a data type/message ID (e.g., ADU ID, PDU ID, IDs associated with pose info, FoV info, media/video frame info, etc.).

The information sent by the WTRU to the network, in any of the message types, may include priority of applications supported by the WTRU. For example, the WTRU may send may send IDs of the applications supported and/or info on the relative/absolute priority values associated with the supported applications.

The information sent by the WTRU to the network, in any of the message types, may include data flows associated with the application. For example, the WTRU may send the number of, and/or IDs associated with, the data/QoS flows supported per application. The WTRU may also send info on the relative/absolute priority values associated with the data/QoS flows of the different applications supported.

The information sent by the WTRU to the network, in any of the message types, may include devices associated with the application. For example, the WTRU may send the number of, and/or IDs associated with, the devices supported and/or the association of the devices per application.

The information sent by the WTRU to the network, in any of the message types, may include data/traffic types associated with the data flows per application. For example, the WTRU may send information on different data/QoS flows associated with an application, where the data type may include video data (e.g., I-frame data, P-frame data, B-frame data), RGB-D data, 360 degrees video data, haptics data, pose/positioning data, audio data, etc.

The information sent by the WTRU to the network, in any of the message types, may include traffic characteristics and/or parameters of data/traffic associated with the data/QoS flows per application. For example, the WTRU may send information on traffic characteristics of the different data/QoS flows associated with an application, including whether the data is periodic, aperiodic, semi-persistent, quasi-periodic, etc. The WTRU may send information on the number of PDUs expected per ADU in one or more flows per-application. The information on the number of PDUs per ADU may also include statistical/distribution information, such as mean, min, max, and/or standard deviation values.

The information sent by the WTRU to the network, in any of the message types, may include QoS requirements and/or expected QoS associated with the data. For example, the WTRU may send the QoS requirements and/or expected QoS of the one or more flows associated with the application, including data rate, latency, reliability, absolute/relative priority values, etc. The information on QoS requirements may also include statistical/distribution info such as mean, min, max, and/or standard deviation values. The WTRU may also indicate that such QoS requirements or expected QoS may be supported on different QoS granularities, such as: per-PDU, per-PDU subgroup (e.g., one or more PDUs) within an ADU, per ADU, per-group of ADUs, per flow. The WTRU may also indicate a time window (e.g., start time, duration, and/or end time) during which such QoS requirements or expected QoS may be applicable to the different QoS granularities.

The information sent by the WTRU to the network, in any of the message types, may include pose information (e.g., orientation, position/location). For example, the pose information may be associated with the measurements in any spatial dimensions (e.g., 6DoF, 3DoF), including but not limited to longitude, latitude, altitude, roll, pitch and/or yaw in one or more coordinate systems (e.g., cartesian, spherical). In an example, the pose info sent by the WTRU may be associated with the orientation and/or position/location of the WTRU. The WTRU may also send info on the movement of the WTRU/user (e.g., rate of movement in terms of linear movement (e.g., distance/second) or rotational movement (e.g., degrees/second). The pose information may include uncertainty information (e.g., certainty in predicted user movement).

The information sent by the WTRU to the network, in any of the message types, may include capability information associated with connectivity. For example, information on interfaces may include the number and/or types of interfaces (e.g., NR Uu, NR SL, WiLAN, Bluetooth, etc.), supported by the WTRU. The capability information on interfaces, possibly supported by the WTRU and/or required by the WTRU for supporting any of the WTRU actions, may include any of the following: bandwidth, number of carriers, number of transmit antennas, number of receive antennas, etc.

The information sent by the WTRU to the network, in any of the message types, may include capability information associated with WTRU actions. For example, the capability information related to WTRU actions, including visual sensing, possibly supported by WTRU (e.g., sensors, camera associated with WTRU) and/or required by WTRU, may include any of the following: FoV resolution (e.g, megapixel count), aperture size, shutter lag and startup time, image quality (e.g., min/max range), zoom lens options, image stabilization, exposure settings, battery life, sound/audio, capability to merge overlapping frames from different angles (e.g., stitching frames from individual captures together for panoramic image/video).

The information sent by the WTRU to the network, in any of the message types, may include preferred configuration information. For example, the WTRU may send to the network one or more preferred mapping configurations and/or forwarding configurations, including specific parameters associated with the mapping/forwarding configurations, for supporting any WTRU actions that may be performed/supported by the WTRU and/or by any another associated WTRU/device. The forwarding configurations sent by the WTRU associated with the supported and/or requested UP/CP configurations (e.g., radio bearers, LCHs, links) may include latency requirements, a data rate requirement (e.g., in Mbps), reliability requirements, absolute/relative importance/priority values associated with the UP/CP configurations (e.g., radio bearers, logical channels, links), and/or LCP configuration(s).

In an example (e.g., for PDUs) latency requirements may be expressed in terms of Packet Delay Budget (PDB) associated with IP packets/PDUs, data rate may be expressed in terms of bit rate (e.g., min, max, average, guaranteed) associated with one or more PDUs (e.g., individual PDU, group of PDUs, burst), and reliability may be expressed in terms of Packet Error Rate (PER). In another example (e.g., for ADU(s)), latency requirements may be expressed in terms of Application Delay Budget or Frame Delay Budget associated with ADU (e.g., video/media frames), data rate may be expressed in terms of bit rate (e.g., min, max, average, guaranteed) associated with one or more ADUs (e.g., video/media frames), and reliability may be expressed in terms of Frame Error Rate or Application Error rate.

For the LCP configuration, the WTRU may indicate the LCP rules/restrictions (e.g., restrictions associated with mapping from DRB/LCHs to configured resource grants) that may be applied for a set of forwarding configurations, whether such LCP rules/restrictions may be temporarily changed for a time duration, conditional LCP configurations applicable when detecting certain configured events (e.g., surge in number of PDUs/data with high QoS requirements), and/or fallback/default LCP configurations.

The WTRU may associate and/or indicate weight/probability values for different mapping configurations and/or forwarding configurations when sending request(s) related to a preferred configuration. The weight/probability value may be determined based on the likelihood of a configuration to be applied during transmission and/or other application/AS-layer information/indication, for example. The network may use such weight/probability information for determining and providing to the WTRU a combined configuration and/or for activating/deactivating a configuration that may match with the weight values indicated by the WTRU, for example.

The information sent by the WTRU to the network, in any of the message types, may include indication(s) for activating/deactivating configurations. For example, the WTRU may send an indication to network to request for activating/deactivating a mapping/forwarding configuration and/or parameters associated with the configurations, which may be preconfigured in the WTRU. The WTRU may include the ID of the configuration/parameter when sending the request indication. The request to activate/deactivate a configuration may be accompanied with information on the WTRU action (e.g., splitting/merging QoS flows).

The information sent by the WTRU to the network, in any of the message types, may include measurements related to the application/AS layer. The WTRU may send RSRP, RSRQ, RSSI measurements of the signals, channels, radio links, carriers, etc., which may be associated with the one or more WTRU actions. The WTRU may send pose/positioning measurements (e.g., location information, pose in 6DoF, rate of user/WTRU motion/movement). The WTRU may send the QoS related measurements related to a number of PDUs/ADUs received (e.g., over a time duration), a change in the QoS (e.g., increase/decrease in data rate, latency, reliability), a time-to-live associated with the PDUs/ADUs, and/or a remaining time for delivering the PDUs/ADUs.

The information sent by the WTRU to the network, in any of the message types, may include uncertainty information. For any of the information sent/reported by WTRU, including application layer information (e.g., pose info, QoS flows) and/or AS-layer information (e.g., preferred forwarding configurations), the WTRU may also send the uncertainty associated with the information. In an example where the WTRU may perform prediction or estimation of a parameter (e.g., pose, surge in QoS), the WTRU may indicate to network the uncertainty associated with the estimation/prediction.

The embodiments described herein may use one or more of the above pieces of information (e.g., assistance information, preferred configurations) sent by the WTRU to the network.

The WTRU may receive configuration/assistance information from the network for supporting differentiated QoS. For example, the WTRU may receive configuration/assistance information for enabling the WTRU for supporting any procedures, mechanisms, rules, actions etc., associated with handling differentiated QoS during data transmissions and/or receptions of data/PDUs/ADUs in one or more data/QoS flows. The configuration/assistance information may be received by the WTRU from the network periodically (e.g., with one or more configured periodicity values), aperiodically/dynamically (e.g., status indication/information or request/request messages) and/or on a semi-persistent basis (e.g., sent with a periodicity value over a time window/duration).

The WTRU may receive the configuration/assistance information via one or more of the following: RRC signaling and/or messages (e.g., dedicated/unicast signaling, broadcast/SIB); control PDUs associated with any of the AS layers (e.g., SDAP control PDU, PDCP control PDU, etc.); a DL MAC CE; DCI; non-AS (NAS) layer signaling (e.g., PDU session related messages); and/or application layer signaling/messages.

The configuration/assistance information that is received by the WTRU from the network may include one or more of the following: mapping/forwarding configurations and/or parameters; AS layer status information/indications; validity information; threshold values; request/assistance information on pose/movement; and/or request/assistance information on spatial/FoV information.

The configuration/assistance information that is received by the WTRU from the network may include mapping/forwarding configurations and/or parameters. For example, the WTRU may receive one or more configurations and/or sets of configuration parameters to be applied at different layers of AS protocol stack (e.g., RRC, SDAP, PDCP, RLC, MAC, PHY or any other layer). The configurations/parameters to be applied at different layers may include configurations/parameters for SDAP/PDCP (e.g., 1-to-1, 1-to-M or N-to-M mapping configurations, markings/indications/IDs to apply (e.g., associated with handling QoS flows, ADU), and/or a range of values associated with importance/priority info to identify in the PDUs/ADUs)); configurations/parameters for PDCP (e.g., IDs and sequence numbers to apply, RoCH configuration, security/encryption parameters, and/or a packet duplication configuration); configurations/parameters for RLC (e.g., parameters for AM/UM/TM operation); configurations/parameters for MAC (e.g., LCH parameters (e.g., priority, PBR, BSD for PDU and/or ADU level), LCP configurations (e.g., rules/restrictions/policy for PDU and/or ADU level handling, time duration for changing between different LCP rules/policy), and/or configurations for multiplexing/assembly); and/or configurations/parameters for PHY (e.g., MCS, HARQ configurations).

The WTRU may receive one or more sets of configuration parameters associated with a default configuration, which may be activated and/or used during normal scenarios for transmitting/receiving data, for example. The WTRU may also receive another set of configuration parameters which may be associated with exceptional operation, which may be activated and/or used when detecting a triggering event/condition (e.g., as described herein).

The WTRU may receive default priority values corresponding to forwarding configurations (e.g., DRBs/LCH) associated with an application. For example, a first forwarding configuration may be associated with a first priority value and second forwarding configuration may correspond to a second priority value. The first and second forwarding configurations may be associated with the same application. A first set of priority values may be intended to achieve a default QoS performance (e.g., default latency, default data rate) and a second set of priority values may be intended to achieve exceptional QoS performance (e.g., surge/burst data rate, very low latency) for the PDUs in the first and second forwarding configurations during transmission.

The configuration/assistance information that is received by the WTRU from the network may include AS layer status information/indications. The AS layer status information/indications may include identifiers/IDs, status of mapping/forwarding configurations, and/or flow control. For example, the WTRU may receive information on one or more IDs to apply during transmission/reception, including one or more of the following: WTRU ID(s) (e.g., C-RNTI, I-RNTI, NAS IDs, TMSI/IMS); ID(s) associated with application (e.g., application ID, service ID, session ID, application configuration ID); group ID(s) (e.g., associated with a group of QoS flows, group of forwarding configurations, group of devices/WTRUs); ID(s) of individual QoS flows, mapping configurations, forwarding configurations; and/or data type/message ID(s) (e.g., ADU ID, PDU ID). The WTRU may receive the information on achieved/achievable QoS when using one or more mapping/forwarding configurations. For example, such information may be received by the WTRU in terms of the data rate, latency (e.g., expected, remaining latency), reliability, and/or achievable/achieved priority when transmitting/receiving data/PDUs/ADUs. The WTRU may also receive statistical/relative/absolute information associated with the achieved/achievable QoS, in terms of mean, max, min, and/or standard deviation, etc., for example. The WTRU may receive from the network explicit or implicit flow control indications indicating whether to start/increase/decrease/suspend/stop transmission of PDUs/ADUs, possibly in terms of achieving an indicated rate of transmission, latency, and/or reliability, in one or more forwarding configurations.

The configuration/assistance information that is received by the WTRU from the network may include validity information. For example, the WTRU may receive validity information associated with the mapping/forwarding configurations, indicating whether/when the configurations (e.g., mapping and/or forwarding configurations) may be considered to be valid or invalid, based on one or more triggering events/conditions. The WTRU may also receive information on whether the configurations are to be deactivated and/or released when determining them to be invalid. The WTRU may receive information on whether the configurations are to be considered as valid/invalid based on the RRC state of the WTRU (e.g., CONNECTED, INACTIVE, IDLE) and/or when transitioning between different RRC states.

The configuration/assistance information that is received by the WTRU from the network may include threshold values. The threshold values may include one or more of a buffer occupancy threshold; expected threshold time values; expected data rate (EDR) threshold values; expected reliability threshold values; a pose difference threshold; a WTRU movement threshold value; and/or a correlation time window.

The threshold values may include a buffer occupancy threshold value. For example, the buffer occupancy threshold value(s) associated with one or more forwarding configurations may indicate the maximum/minimum amount of data/PDUs/ADUs (e.g., in terms of total payload size/volume) that may be included in the buffer.

The threshold values may include expected threshold time values. For example, the WTRU may receive one or more expected threshold time values or expected time of arrival (ETA) threshold values corresponding to the expected time for receiving a PDU/ADU in a data flow, where the PDU may be the first PDU associated with an ADU or any of the subsequent PDUs after receiving the earlier PDUs. The ETA threshold values may be associated with the expected latency for the second PDU/ADU after receiving/transmitting the first PDU/ADU with a first latency value. The ETA threshold values may be associated with the expected latency for the PDUs/ADUs in a second associated data/QoS flow after receiving/transmitting the PDUs/ADUs in a first data/QoS flow with a first latency value. An ETA threshold value may be associated with a time duration or timer value. For example, the WTRU may start a timer at a time instance when receiving/transmitting the first PDU, and may stop the timer when the timer expires at the time instance corresponding to the threshold time value and/or when receiving/transmitting the second PDU (e.g., the first and second PDUs may be associated with the same ADU).

The threshold values may include expected data rate (EDR) threshold values. The WTRU may receive one or more EDR threshold values associated with the data rate expected for receiving/transmitting PDUs/ADUs in one or more data/QoS flows. The data rate may correspond to one or more of the following units: PDUs/ADUs per second, frames per second, and/or bits per second, etc. The EDR threshold values may be associated with the expected data rate for the second PDU/ADU after receiving/transmitting the first PDU/ADU with a first data rate value. The EDR threshold values may be associated with the expected data rate for the PDUs/ADUs in a second associated data/QoS flow after receiving/transmitting the PDUs/ADUs in a first data/QoS flow with a first data rate value.

The threshold values may include expected reliability (EER) threshold values. The WTRU may receive one or more EER threshold values associated with the reliability expected for receiving PDUs/ADUs in one or more data/QoS flow. The reliability values may correspond to one or more of the following units: packet error rate, frame/ADU error rate, and/or probability of error, etc. The EER threshold values may be associated with the expected reliability for the second PDU/ADU after receiving/transmitting the first PDU/ADU with a first reliability value. The EER threshold values may be associated with the expected reliability for the PDUs/ADUs in a second associated data/QoS flow after receiving/transmitting the PDUs/ADUs in a first data/QoS flow with a first reliability value.

The threshold values may include a pose difference threshold. The pose difference threshold value may correspond to the difference between the measurement of pose information at a first time instance and a second time instance, where the time instances may correspond to one or more of the following units: time slots, symbol duration, SFN, and/or seconds/milliseconds.

The threshold values may include a WTRU movement threshold value. The WTRU movement threshold may correspond to the difference between the location or rotation angle of WTRU between a first time instance and a second time instance, where the time instances may correspond to one or more of the following units: time slots, symbol duration, SFN, and/or seconds/milliseconds.

The threshold values may include a correlation time window. The correlation time window may correspond to the minimum time difference between two or more triggering events (e.g., pose info measurements, QoS events), where the events may be considered as correlated with each other when they occur within the correlation time window. When the events occur at time instances beyond the correlation time window, they may be considered as independent. In an example, the WTRU may use the correlation time window for determining whether to send an indication to the network (e.g., indicating a change in WTRU location/movement or change in QoS).

The configuration/assistance information that is received by the WTRU from the network may include request/assistance info on pose/movement. The request/assistance for pose/movement info may be associated with measurements in any spatial dimensions (e.g., in 6DoF), possibly in one or more coordinate systems (e.g., cartesian, spherical).

The configuration/assistance information that is received by the WTRU from the network may include request/assistance info on spatial/FoV information. Request/assistance info on FoV information may correspond to the dimensions of FoV (e.g., perimeter/border/size/boundaries/angle width of FoV), which may be expressed in terms of measurements in any spatial dimensions, in one more coordinate systems (e.g., cartesian, spherical). The WTRU may receive information on the FoV of its own sensors/camera (e.g., which may be co-located with WTRU). The information on FoV, including extended FoV, received by the WTRU may include the dimensions, a time duration when the indicated FoV may be valid, and/or area (e.g., list of cells IDs, list of cell sector IDs, list of directions within a cell) where the indicated FoV information may be valid.

The embodiments described herein may use one or more of the above configuration/assistance information received by the WTRU from the network.

Triggering events/conditions for supporting differentiated QoS at the WTRU may occur. The WTRU may be configured with one or more events/conditions related to triggering one or more of the WTRU actions described above, including sending assistance information/indications to a network, receiving configuration/assistance information from the network, changing mapping configurations, changing forwarding configurations, etc.

Such triggering events/conditions may be related to ensuring/supporting differentiated QoS and/or for meeting expected QoS when transmitting/receiving PDUs/ADUs in one or more associated QoS flows. Such triggering events/conditions may dictate whether and which action may be performed by WTRU. Such triggering events/conditions may dictate when (e.g., at what time instant) an action may be performed by WTRU (e.g., any of the events/condition/criteria described below is satisfied). The conditions may be based on one or more of the following: an indication/information from the network; an indication/information from application/higher layers; a buffer status and loading at forwarding configurations (e.g., DRBs/LCHs); a change in configuration(s) at the WTRU; timing/timestamp information (e.g., which may be associated with expected QoS); measurements on Uu link(s); compensation based on expected QoS; a property associated with the link/channel to which a forwarding configuration is associated; and/or detection of QoS events (e.g., a surge in high importance data).

The triggering events/conditions may include an indication/information from the network. The WTRU may receive from the network (e.g., gNB) an indication/information on the expected/achievable QoS for transmission over a Uu link (e.g., in UL and/or DL). The information may be received semi-statically, during/upon configuration, and/or dynamically. The WTRU may trigger an action (e.g., determining/selecting a mapping or forwarding configuration) as described herein based on the indication/information received from network. The expected/achievable QoS may be indicated on the basis of per-PDU, per-ADU, per-QoS/data flow, per forwarding configuration, and/or per-mapping configuration. The WTRU may receive, from the gNB, the information on the expected/achievable QoS implicitly, based on one or more of the following: a number of times HARQ feedback is received, a size and/or timing for allocation of resource grants (e.g., configured grant, dynamic grants), an allocation of retransmission grant corresponding to one or more forwarding configurations (e.g., LCHs/DRBs/BWPs), and/or a de-prioritization of PUSCH/grant for one or more LCHs due to intra/inter-WTRU prioritization, etc. For example, the WTRU may be triggered to perform any of the WTRU actions described herein when receiving an indication from the network (e.g., in RRC, MAC CE, other control PDU or DCI). The indication received by the WTRU may be related to the change/update in mapping/forwarding configuration at the WTRU and/or expected QoS associated with the one or more QoS flows.

The triggering events/conditions may include an indication/information from application/higher layers. The WTRU may perform one or more WTRU actions when receiving an indication from application/higher layers. Such indication may include information on the change of traffic characteristics/patterns associated with the generation/processing/reception PDUs/ADUs in one or more QoS/data flows. The application may indicate to the WTRU the information on the expected number of QoS flows which may be associated with the application, the expected number of PDUs per ADU, the expected frame/ADU in a subsequent time instances (e.g., next frame generation instance), the expected change in the distribution of importance/priority of PDUs generated, the expected increase/decrease in latency (e.g., due to processing at codec/application) and/or jitter for delivering the PDUs/ADUs, the expected change in the time-to-live associated with PDUs/ADUs, and/or the expected change in WTRU/user motion/movement (e.g., increase/decrease in rate of motion), etc.

For example, the WTRU may receive an indication from application/higher layers indicating the arrival of one or more PDUs (e.g., in a batch/burst) prior to the reception of the PDUs. The information on the arrival of the PDUs may include the expected timing (e.g., time slot/frame) of PDU/ADU generation at application, and/or the expected timing of reception at the WTRU. The WTRU may be triggered to perform one or more of the WTRU actions described herein based on an indication of importance/priority for the transmitting PDUs. The WTRU may trigger an action (e.g., change mapping/forwarding configuration) for sending delayed PDUs with compensation (e.g., low latency) when receiving an indication containing a importance/priority value higher than a threshold.

The triggering events/conditions may include a buffer status and loading at forwarding configurations (e.g., DRBs/LCHs). The buffer status and loading at forward configurations may include a condition associated with one or more of the following measurements (e.g., compared to a threshold): the amount of PDUs/ADUs in one or more buffers associated with the forwarding configuration(s), possibly over a period of time; the rate of arrival/departure of PDUs/ADUs in one or more buffers associated with the forwarding configuration(s); the average, maximum, and/or minimum size/volume of PDUs/ADUs in an buffers associated with the forwarding configuration(s) (e.g., the number of PDUs in LCH buffer); a measure of the amount of time spent by one or more PDUs/ADUs in buffers associated with the forwarding configuration(s); and/or the number of forwarding configurations meeting a condition/threshold associated with the amount of data, arrival rate, PDU/ADU size, etc.

For example, a WTRU may perform any of the actions described herein (e.g., change the mapping configuration, change the forwarding configuration, and/or send a report or status indication) if at least one PDU/ADU in a forwarding configuration is in the buffer for a period of time larger than a threshold time value and/or if the buffer status of the forwarding configuration exceeds a threshold. Other buffer status metrics that may be monitored for determining the expected QoS may include the number of PDUs/ADUs buffered which are above/below a configured threshold in one or more associated forwarding configurations, and/or the rate of PDU/ADU arrival/departure in the buffer with respect to a configured arrival/departure rate. The WTRU may determine the number of PDUs/ADUs received over a time duration/window for determining whether the rate of PDUs received is within the range expected for the QoS. The WTRU may then determine/select a mapping configuration for adjusting/compensating the expected QoS if the PDUs/ADUs are received outside of the range expected for QoS.

The triggering events/conditions may include a change in configuration(s) at the WTRU. The WTRU may be triggered to perform one or more WTRU action(s) (e.g., sending an indication/report to network) when changing the mapping configuration and/or forwarding configuration, including changing at least one of the parameters at the mapping configuration (e.g., mapping a QoS flow to a new forwarding configuration), at the DRB/LCHs (e.g., priority, PDB, PBR) and/or at LCP configuration. For example, the WTRU may be triggered to perform one or more WTRU action(s) when the CDRX/DRX configuration and/or any of the associated parameters applied at the WTRU is modified/updated, which may impact the transmission/reception pattern and/or achievable QoS during data transmission.

The triggering events/conditions may include timing/timestamp information, which may be associated with an expected QoS. For example, the WTRU may track the timing related information (e.g., timestamp, marker and/or timing control PDU) in the one or more PDUs/ADUs received in an earlier time window for determining the latency or jitter. The timing information may then be used for determining the expected QoS for upcoming PDUs/ADUs in the next time window. The timing information may be determined/indicated as a deadline/latency bound and/or survival time that may be satisfied on a per-PDU, per-ADU, or per-QoS flow basis. Such timing information may be determined across one or more associated/correlated QoS flows, for example. In another example, the timing information may also be determined/indicated on a count basis (e.g., PDU/ADU count). The WTRU may trigger an action (e.g., determining the mapping/forwarding configuration) as described herein when determining the timing information and its impact on whether the expected QoS may/may not be met.

The WTRU may send the information on the expected QoS, based on the measurements associated with the time duration the PDUs/ADUs spend in the forwarding configuration (e.g., elapsed time from reception of PDUs/ADUs to transmission). The WTRU may send information/indications/reports to the network (e.g., as described herein) periodically or based on a setting/expiry of a configured timer.

The triggering events/conditions may include measurements on Uu link(s). For example, the WTRU may perform measurements over the Uu link (e.g., corresponding to RSRP, RSSI, CQI and/or CSI) for determining the expected QoS. The channel/load measurements made over a certain configured time duration may indicate whether the PDUs/ADU are able to achieve the expected QoS during transmission or may exceed the QoS budget (e.g., latency). The WTRU may trigger an action (e.g., determining mapping configuration) as described herein based on the measurements on Uu link.

The WTRU may determine the Uu link conditions based on the number of ARQ/HARQ (e.g., ACK/NACK) feedback messages and/or ARQ/HARQ retransmissions made over one or more HARQ processes associated with the forwarding configurations applied for sending the PDUs/ADUs. The expected QoS may then be determined based on a (e.g., configured) mapping function between the feedback/retransmission (ReTx) count and the expected QoS. As an example, a ReTx count above a threshold may translate to poor Uu link/channel conditions, and hence, reduced expected QoS. In another example, the WTRU may determine the channel/link conditions based on CSI reports received from the network.

The WTRU may be triggered to perform one or more WTRU action(s) and/or send an indication to network when channel measurement(s) made (e.g., RSRP, RSSI, RSRQ, CQI, CSI) on Uu link increase/decrease with respect to a configured threshold and/or remain above/below a threshold for a certain time duration. The WTRU may be triggered to perform one or more WTRU action(s) when one or more QoS-related measurements (e.g, latency measured for PDUs/ADUs in one or more forwarding configurations) exceeds a certain threshold. The WTRU may trigger an action (e.g., as described herein) based on a determination of the time duration/jitter or change in the time duration/jitter between reception of consecutive PDUs associated with an ADU. For example, the WTRU may infer an increase/decrease in the jitter between consecutive PDUs for determining whether the processing load at application/higher layer is high/low. For determining the time duration, the WTRU may set a timer when a first PDU arrives and reset the timer when a second PDU associated with the same ADU arrives.

The triggering events/conditions may include compensation based on expected QoS. The WTRU may be triggered to perform one or more WTRU action(s) based on determination of expected QoS for one or more PDUs/ADUs, where the expected QoS may indicate the PDUs may be either delayed or arrive early. The WTRU may trigger an action such that the delayed PDUs are transmitted with a determined compensation amount. In an example, the action(s) may be triggered when detecting a change (e.g higher/lower) in the expected QoS for the PDUs/ADUs by a certain threshold. The WTRU may determine the delayed PDU to be sent using a forwarding configuration that enables satisfying a compensation amount, where the compensation amount may be determined by subtracting the expected latency from actual latency.

The triggering events/conditions may include a property associated with the link/channel to which a forwarding configuration is associated. A WTRU may be configured with a property specific to the forwarding configuration/link/channel, such as a forwarding configuration/link/channel priority and/or a configuration parameter enabling/disabling the specific action for the forwarding configuration/link/channel. For example, a forwarding configuration/link/channel configured with high priority may allow the WTRU to change a (e.g., any) configuration (e.g., with respect to an initial or default configuration). The WTRU may change the parameters of a forwarding configuration associated with a high priority as long as the change impacts only other lower priority forwarding configurations.

The triggering events/conditions may include detection of QoS events (e.g., a surge in high-importance data). QoS events may include surge events associated with an increase in the number of PDUs/ADUs or data volume, possibly over a time window, indicated/marked with high importance/priority, for example. Likewise, other QoS events may include QoS deflation associated with a decrease in the number of PDUs/ADUs or data volume over a time window. The WTRU may be triggered to perform one or more WTRU action(s) when detecting one or more QoS events, possibly by considering the indicated/determined the duration the QoS events are expected to persist. The WTRU may then perform other WTRU action(s) that may result in returning to the default configurations, possibly after the end of the detected QoS events.

The WTRU may determine the association of PDUs to ADU based on explicit/implicit indications/parameters. The WTRU may determine whether the PDUs in one or more QoS/data flows transmitted by the WTRU (e.g., in UL) and/or received by the WTRU (e.g., in DL) are associated with an ADU and/or an application/high layer function (e.g., NAS). The WTRU may determine the association of the PDUs to ADU and/or application/higher layer function based on an explicit indication and/or implicit parameters/identifiers detectable by the WTRU in the PDUs or QoS flows.

The parameters/identifiers for determining the association of PDUs to ADU may be configured in the WTRU (e.g., via RRC signaling, NAS-layer signaling, and/or application/higher layer signaling). The parameters/identifiers used by the WTRU for identifying the association of PDUs to ADU may include one or more of the following: identifiers/IDs associated with flows and/or applications; priority/importance information associated with flows; temporal/timing information in associated flows; spatial/pose information in associated flows; and/or an explicit indication from application/higher layers/AS-layers.

The parameters/identifiers used by the WTRU for identifying the association of PDUs to ADU may include identifiers/IDs associated with flows and/or applications. The WTRU may determine a first PDU and/or a second PDU in a same QoS flow or different QoS flows are associated with an ADU based on detecting a common ID associated with the ADU. Such ID may be detected within the PDUs (e.g., in header and/or payload) in one or more QoS flows. The ID of the ADU and/or application associated with the ADU may be preconfigured in the WTRU.

The parameters/identifiers used by the WTRU for identifying the association of PDUs to ADU may include priority/importance information associated with flows. The WTRU may determine a first PDU and/or a second PDU in one or more QoS flows are associated with an ADU based on detection of common and/or similar importance/priority indications in the PDUs (e.g., in header and/or payload) in the QoS flows. Such importance/priority indications may be related to spatial or temporal indications. The WTRU may determine that the PDUs are associated with an ADU when the importance/priority indications detected by the WTRU (e.g., in PDU header or payload) are above/below one or more importance/priority threshold values.

The parameters/identifiers used by the WTRU for identifying the association of PDUs to ADU may include temporal/timing information in associated flows. The WTRU may determine a first PDU and/or a second PDU in one or more QoS flows are associated with an ADU when the PDUs are received by the WTRU within a time duration/window. The time duration/window may correspond to the time difference between the reception time of a first PDU (e.g., at t1) and a second PDU (e.g., at t2) within the same QoS flow, for example. Likewise, the time duration/window may correspond to the time difference between the reception time of a PDU in a first QoS flow (e.g., at t1) and the reception time of a PDU in a second QoS flow (e.g., at t2), for example. The WTRU may determine that the first and second PDUs in the same or different QoS flows are associated with an ADU when the time difference (e.g., t2−t1) is less than a time duration/window threshold value. In an example, the time duration/window threshold value may be associated with the framerate used by the application/higher layer (e.g., 60 Hz, 120 Hz) for generating the ADUs/PDUs. The WTRU may determine that the first and second PDUs in one or more QoS flows are associated with an ADU based on a common format and/or granularity of the timing information (e.g., timestamps, packet count, sequency numbers) carried in the PDUs.

The parameters/identifiers used by the WTRU for identifying the association of PDUs to ADU may include spatial/pose information in associated flows. The WTRU may determine that a first PDU and/or a second PDU in one or more QoS flows are associated with an ADU when the PDUs carrying the spatial information correspond to common spatial parameters/IDs. The spatial parameters/IDs, for example, may include one or more of the following: direction/orientation of FoV of the user/WTRU, slice/tile of the video/media frame, location info (e.g., coordinates of the WTRU), and/or pose info, etc. The spatial parameters/IDs may be determined by the WTRU based on detection of certain PDUs carrying spatial information (e.g., pose/control PDU which may be identified by WTRU based on data type identifiers) or detection of other PDUs which may contain spatial information within the PDUs (e.g., in the header and/or payload).

The parameters/identifiers used by the WTRU for identifying the association of PDUs to ADU may include an explicit indication from application/higher layers/AS-layers. The WTRU may determine that a first PDU and/or a second PDU in one or more QoS flows are associated with an ADU when receiving an explicit indication/message from higher-layers/AS-layers in the WTRU or network. In an example, the WTRU may receive, in the indication, the timing information (e.g., periodicity, burst time window/duration) during which the PDUs are associated with an ADU. Outside of the timing information (e.g., burst duration), the WTRU may assume that the PDUs are uncorrelated and/or not associated with an ADU.

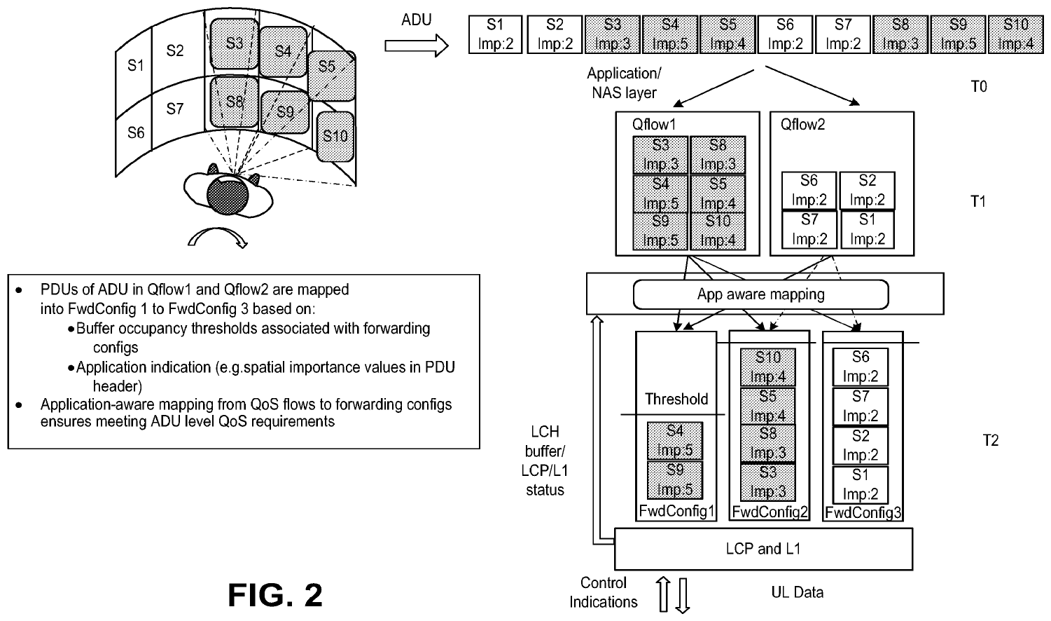

The WTRU may perform mapping of PDUs associated with an ADU in different QoS flows to forwarding configurations. The WTRU may use a mapping configuration for performing mapping of PDUs associated with an ADU in one or more QoS flows to one or more forwarding configurations based on AS layer indications and higher layer indications (e.g., as shown in FIG. 2). FIG. 2 shows an example of mapping PDUs associated with an ADU in different QoS flows to forwarding configurations. For example, as shown in FIG. 2, PDUs (e.g., S1 to S10) of an ADU (e.g., video frame viewed by user) in a first QoS flow (e.g., Qflow1) and a second QoS flow (e.g., Qflow2) may be mapped into a first forwarding configuration (e.g., FwdConfig1), a second forwarding configuration (e.g., FwdConfig2), or a third forwarding configuration (e.g., FwdConfig3) based on buffer occupancy thresholds associated with the forwarding configurations and application indication(s) (e.g., spatial importance values in PDU header). The WTRU may perform the mapping of PDUs of ADU in a manner that may ensure the ADU level QoS is satisfied when transmitting the mapped data/PDUs in forwarding configurations in UL.

For supporting such mapping of the PDUs of ADU, the WTRU may receive configuration information from the network (e.g., RRC), consisting of one or more forwarding configurations (e.g., one or more DRBs or LCHs), where a (e.g., each) forwarding configuration may be associated with one or more buffer occupancy threshold values. The WTRU may also receive a mapping configuration from the network for performing the PDU mapping. The mapping configuration may be applied at any of the AS layers in the WTRU including SDAP, PDCP, RLC, MAC or in another layer, for example, possibly as one or more of the subfunctions within the AS layers. The WTRU may also receive other configuration and/or assistance information from the network as described herein. Additionally, the WTRU may receive the configuration/assistance information, possibly from high layers/application, which may be used by the WTRU for translating the higher layer messages and/or indications in the PDU/ADU headers (e.g., spatial/temporal importance values, QFI) to identifiers/markers/information (e.g., priority) which may be handled at AS layers (e.g., SDAP, PDCP, RLC, MAC, PHY or any other layers) when transmitting the data/PDUs.

When receiving the PDUs of an ADU, the WTRU may determine the association of the PDUs to an ADU, possibly in the different QoS flows, based on the indications/IDs in the PDU (e.g., sequence number/ID of ADU in the header of the PDUs which may be associated with the ADU) or other approaches (e.g., the PDUs that are received within a time/burst window may be determined to be associated with the same ADU). For the PDUs in a QoS flow, which may be a subset or all PDUs belonging to an ADU, the WTRU may determine the expected traffic information, such as amount of data volume, when mapping the PDUs to a first forwarding configuration. The first forwarding configuration may be applied for transmitting data/PDUs that are identified/marked with importance/priority values (e.g., spatial/temporal importance value in the PDU header) greater or less than a threshold value, for example. The expected traffic information may include the expected amount of data volume in the buffer of the first forwarding configuration, expected data rate achievable during transmission of PDUs, expected latency for transmitting the PDUs, expected priority applied in the LCP procedure and/or other L2/L1 procedures during transmission, and/or the expected reliability achievable, etc. Such expected traffic information may be determined based on one or more of the following: data/PDUs which are in the QoS flows, the configuration parameters applied in the forwarding configurations, and/or loading/traffic status information and/or assistance information received from AS layers (e.g., from PDCP, RLC, MAC, PHY, RRC) or from the network, for example. In an example, the WTRU may determine the expected amount of data volume when mapping the PDUs from a QoS flow to the first forwarding configuration based on the sum of data volume of the PDUs expected to be mapped and sum of data volume which is in buffer of the forwarding configuration.

If the WTRU determines that the expected data volume is less than the buffer occupancy threshold value associated with the forwarding configuration, the WTRU may map the PDUs in the QoS flow using the mapping configuration to the forwarding configuration. If the WTRU determines that the expected data volume is greater than the buffer occupancy threshold value associated with the forwarding configuration, the WTRU may send an indication to network for indicating the triggering of a potential buffer overload event, for example. The WTRU may send the indication in AS layer signaling (e.g., RRC message, control PDU associated with any of AS layers (e.g., SDAP, PDCP, RLC, etc.), MAC CE or UCI). The indication sent by the WTRU may include any of the following information, for example: the ID of the forwarding configuration, ID of the overload event, amount of data overload/overflow, expected delay due to overload, request for resources for handling the overload event (e.g., overload data, total data in buffer), and/or priority/urgency associated with the overload event, etc. The WTRU may determine how to address the potential buffer overload event based on the amount of data/PDUs in the QoS flows, the indications/markers (e.g., importance values) associated with the data/PDUs in QoS flows and AS-layer/network indications (e.g., amount of data or load in the forwarding configuration with respect to buffer occupancy threshold values). The WTRU may split/partition the data/PDUs in QoS flows before mapping to forwarding configurations or perform flow control by controlling the amount of data mapped to the forwarding configurations, possibly for mitigating any costs associated with not meeting the ADU-level QoS and preventing buffer overflow events.

The WTRU may receive an indication from network in AS layer signaling (e.g., RRC, control PDU, MAC CE, DCI), possibly after sending an indication to network, where the received indication may indicate one or more of the following, for example: whether and how to split the data/PDUs in the QoS flow, the thresholds related to importance/priority marking to apply when splitting the data/PDUs in QoS flow, updated threshold values related to buffer occupancy to apply in the forwarding configuration, updated traffic information in terms of data rate achievable/delay expected/reliability expected when transmitting data in the forwarding configuration, and/or radio resources (e.g., configured grants, dynamic grants, BWPs, CCs) for addressing the overload event, etc.

The WTRU may determine one or more sets of PDUs in the QoS flow based on the indications received from higher layers or in the PDUs (e.g., importance/priority value indicated/marked in the PDU header) and/or other indications received from AS layers/network. For example, the WTRU may determine a first set of PDUs for any PDUs in QoS flow(s) which are indicated/marked with an importance/priority value greater than an importance threshold value. Likewise, the WTRU may determine a second set of PDUs for any PDUs in the QoS flow(s) which are indicated/marked with an importance/priority value less than an importance threshold value. The WTRU may then use the mapping configuration for mapping the first set of PDUs to the first forwarding configuration and mapping the second set of PDUs to a second forwarding configuration. The first forwarding configuration may be used for transmitting PDUs of higher importance/priority (e.g., above an importance/priority threshold) and the second forwarding configuration may be used for transmitting PDUs of lower importance/priority (e.g., below an importance/priority threshold). The mechanism for splitting/partitioning of the data/PDUs in the QoS flows, possibly at the mapping configuration, based on the importance/priority indications associated with the PDUs may be applied for preventing buffer load events at the forwarding configurations. Additionally, splitting/partitioning the PDUs in the QoS flow based on the importance/priority indications of PDUs may ensure that the ADU level QoS (e.g., data rate, latency, reliability) is satisfied by mapping the PDUs based on the awareness of the association of the PDUs to ADU and the awareness of higher layer/AS layer indications.

The WTRU may transmit the data/PDUs which are mapped to the one or more forwarding configurations using the procedures at L2 (e.g., LCP, multiplexing, assembly to transport block), and/or L1 (e.g., modulation), and may use resource grants received from the network.

The WTRU may switch between different mapping configurations for mapping PDUs of ADUs to forwarding configurations. The WTRU may switch between different mapping configurations for mapping the PDUs associated with an ADU to one or more forwarding configurations, possibly when detecting QoS-related events. The QoS-related events may include QoS surge events associated with an increase in the number of PDUs or data volume, possibly over a time window, indicated/marked with high importance/priority. Likewise, another QoS event may include QoS deflation event(s) associated with a decrease in the number of PDUs or data volume over a time window. The WTRU may switch between different mapping configurations for ensuring that the ADU level QoS are satisfied when transmitting the mapped data/PDUs in forwarding configurations in UL.

For supporting switching between mapping configurations, the WTRU may receive configuration information from the network (e.g., RRC), that includes one or more of the following: one or more mapping configurations (e.g., including a first mapping configuration and a second mapping configuration); one or more forwarding configurations (e.g., DRBs, LCHs, resource grants), where a (e.g., each) forwarding configuration may be configured with parameters for achieving certain QoS during data transmission (e.g., average data rate, latency and reliability); and/or one or more threshold values indicating the upper/lower bound for change in QoS (e.g., increase or decrease in data/PDUs with high importance/priority or high QoS requirement) associated with the first mapping configuration.

The configuration information that the WTRU receives from the network (e.g., RRC) may include one or more mapping configurations. In an example, the first mapping configuration may be activated (e.g., for direct usage without the WTRU having to request for activation) and the second mapping configuration may be deactivated (e.g., the WTRU may send a request for activation prior to usage). The first mapping configuration may be used for handling average or expected data transmission scenarios where the amount of data/number of PDUs with different importance/priority levels to be mapped from QoS flows and transmitted in UL is within an average level (e.g., above and/or below threshold amount/level). The second mapping configuration may be associated with and used during exceptional scenarios where the amount of data/PDU with different importance/priority levels to be mapped from QoS flows and transmitted in UL is relatively higher/lower than the average/expected scenarios. The mapping configurations may include the mapping parameters/rules indicating how the M-to-N mapping relation may be done for mapping the data/PDUs from M QoS flows to N forwarding configurations. For example, the first mapping configuration may be associated with a first M-to-N mapping relation (e.g., to relatively low number of forwarding configurations) and the second mapping configuration may be associated with a second M-to-N mapping relation (e.g., to relatively high number of forwarding configurations). The WTRU may receive the allowed set of mapping parameters (e.g., parameter IDs) which may be modified by the WTRU when determining the second mapping configuration.

When receiving the PDUs of an ADU, the WTRU may determine the association of the PDUs to an ADU, possibly in different QoS flows, based on the indications/IDs in the PDU (e.g., ID of ADU in the PDU header), or otherwise as described herein. The WTRU may apply the default/first mapping configuration for mapping the PDUs of ADU to one or more forwarding configurations based on the default parameters in the mapping configuration. The WTRU may apply the mapping configuration at any of the AS layers in the WTRU, including SDAP, PDCP, RLC, MAC or in another layer, for example, as one or more of the subfunctions within the AS layers.

When determining/detecting an QoS event, the WTRU may initiate a procedure for (re) selecting or changing the mapping configuration to apply for mapping the PDUs to forwarding configuration. The WTRU may determine the QoS event based on an indication received from higher layers/AS layers (e.g., indicating an expected surge in high QoS PDUs or change in QoS achievable in AS layers) and/or based on indications/marking in the PDUs in the Qos flow (e.g., number of PDUs with high importance marking are greater than an importance threshold). The WTRU may initially estimate the expected change in QoS (e.g., increase in data rate or increase in latency) when using the existing (e.g., default/first) mapping configuration based on the data/PDUs in the QoS flow (e.g., data volume or number of PDUs with high importance indications/markings) and the AS-layer information associated with loading in the forwarding configuration (e.g., status of other data/PDUs in buffer in terms of time elapsed since arrival in buffer and remaining time for transmission).

If the expected change in QoS is less than a threshold (e.g., the number of PDUs with high importance is less than a threshold), the WTRU may use the first mapping configuration for mapping the PDUs to the associated forwarding configurations. If the expected change in QoS is greater/less than a threshold (e.g., the number of PDUs with high importance is greater than a threshold), the WTRU may determine whether the second mapping configuration is able to address the QoS event associated with expected change in QoS. For example, the WTRU may determine if by using the second mapping configuration, the number of PDUs with high importance in the QoS flows may be mapped to other forwarding configurations that may result in ensuring the expected in QoS to be below/above the threshold and prevent the QoS event. The WTRU may also determine the expected duration for the QoS event to persist based on an indication from higher layer/application, volume of data/PDUs with high importance/priority in buffer, and/or other AS-layer indications. The WTRU may then determine the duration for the second mapping configuration to be activated based on the determined expected duration for the QoS event to persist. The WTRU may determine the mapping parameters to be applied in the second mapping configuration based on the configuration related to allowed parameters received from network, indications/markings in the PDUs in QoS flows and AS-layer indications.

The WTRU may send an indication to the network that indicates the request for activating the second mapping configuration and/or the parameters to be applied in the second mapping configuration. The WTRU may also send any of the following information in the indication: the ID of the mapping configuration requested to be activated, the IDs of the mapping parameters to be changed/activated, the ID associated with the QoS event, the expected duration for using the second mapping configuration, the amount or distribution of data/PDUs with different importance/priority levels, the expected delay when mapping the data/PDUs to forwarding configuration, a request for resources for addressing the QoS event, and/or the priority/urgency indication associated with the QoS event, etc. The WTRU may send the indication in AS layer signaling (e.g., RRC message, control PDU associated with any of AS layers (e.g., SDAP, PDCP, RLC, etc.), MAC CE or UCI).

The WTRU may receive an indication from the network in AS layer signaling (e.g., RRC, control PDU, MAC CE, DCI), where the received indication may indicate one or more of the following: a deactivation indication for deactivating the first mapping configuration (ID), an activation indication for activating the second mapping configuration (ID), IDs of the mapping parameters to be activated/deactivated, validity conditions for activating the second mapping configuration (e.g., time period/duration or detection of another QoS event), and/or any updated parameters associated with forwarding configurations (e.g., updated LCP, priority, PBR, BSD), radio resources (e.g., configured grants, dynamic grants, BWPs, CCs) for addressing the QoS event, etc.

After activating the second mapping configuration, the WTRU may perform the mapping of PDUs of an ADU from the QoS flows to the forwarding configurations using the parameters associated with the second mapping configuration. For example, the WTRU may start a timer when activating the second mapping configuration, possibly when the WTRU is provided with validity conditions (e.g., time period/duration) for using the second mapping configuration. The WTRU may fallback to using the first mapping configuration at the expiry of the timer (e.g., after deactivating the second mapping configuration). Alternatively, when detecting another QoS event (e.g., a number of high importance PDUs in QoS flows drops below a threshold), the WTRU may stop the timer, deactivate the second forwarding configuration and/or fallback to using the first mapping configuration.

The WTRU may transmit the data/PDUs which are mapped to the one or more forwarding configurations using the procedures at L2 (e.g., LCP, multiplexing, assembly to transport block) and/or L1 (e.g., modulation), using resource grants received from network.

The WTRU may determine forwarding configurations for transmitting PDUs of an ADU while ensuring the ADU level latency requirement is met. The WTRU may determine the one or more forwarding configurations to apply when transmitting PDUs associated with an ADU and satisfy the ADU-level latency requirement based on the time when the PDUs are received by the WTRU. The forwarding configurations, configured with suitable set of parameters (e.g., priority, PBR, BSD, LCP) may be determined or selected by the WTRU such that the PDUs that are received from application/higher layer within a threshold time (e.g., deadline) are transmitted using a default forwarding configuration (e.g., default priority). The PDUs that are received after the threshold time may be transmitted using different forwarding configurations with a different set of parameters (e.g., high priority) for meeting the ADU-level latency requirement.

The WTRU may receive configuration information from the network (e.g., RRC) for determining/selecting forwarding configurations. The configuration information may include one or more forwarding configurations (e.g., DRBs, LCHs, resource grants) associated with different parameters and/or first and second threshold time values for receiving the PDUs from the application/higher layer. The different forwarding configurations and/or the parameters of the configurations received by the WTRU may be associated for achieving, during PDU transmission, at least a default priority (e.g., for achieving expected/average latency associated with ADU during normal transmission), high priority (e.g., for achieving minimal latency for expedited transmission) and/or best effort priority (e.g., for achieving higher than average latency). The threshold time values may be associated with meeting the ADU level latency requirement, for example. The second threshold time may be the maximum latency tolerable for sending all PDUs associated with an ADU.

When receiving a first PDU, the WTRU may determine its association with an ADU and/or the time of reception of the PDU based on the indication/marking in the PDU (e.g., ADU ID, timestamp, sequence number, packet count in the PDU header). The WTRU may start a timer after receiving the first PDU and let the timer to run for a duration (e.g., up to the first threshold time value). The WTRU may select a forwarding configuration with default parameters for transmitting the first PDU in UL.

When receiving a second PDU associated with the ADU, the WTRU may determine the time of reception of the PDU based on the indication/marking in the PDU (e.g., timestamp, packet count in the header of PDU). The WTRU may also determine the time of reception of the second PDU based on the timer, which may be set after receiving the first PDU, for example. The WTRU may also determine whether the second PDU is the last PDU associated with the ADU based on the indication/marking in the PDU (e.g., ADU ID, sequence number of PDU, PDU count number, flag indicating last PDU). If the second PDU is determined to be not the last PDU associated with the ADU, and the second PDU is received before the first threshold time (e.g., before expiry of timer), the WTRU may select the forwarding configuration with default parameters for transmitting the second PDU in UL.

Alternatively, if the second PDU is received after the first threshold time (e.g., after expiry of the timer), the WTRU may determine/select a forwarding configuration with parameters (e.g., high priority) that may enable the PDU to be transmitted with lower latency, possibly for compensating for delayed reception at the WTRU. For example, the WTRU may determine, from the time of reception of the second PDU, the amount of latency reduction or compensation (e.g., time difference between the reception time and the first threshold time) that may be applied for expediting the transmission of the PDU. The WTRU may determine/select a forwarding configuration with parameters (e.g., priority) that are suitable or match with the determined latency reduction/compensation. The WTRU may send an indication to the network (e.g., in RRC, MAC CE, control PDU, UCI) consisting of any of the following information: the ID of the determined/selected forwarding configuration, IDs of the parameters of the determined/selected forwarding configuration, a request for activating the selected forwarding configuration, a request to provide information of suitable forwarding configuration, an amount of latency reduction/compensation for sending the delayed PDU, and/or a request for resources for sending the delayed PDU, etc. The WTRU may then send the second PDU using the determined/selected forwarding configuration, possibly after receiving the activation indication, information related to forwarding configuration to apply (e.g., ID, parameters to apply), and resource grants from the network.

If the second PDU is determined to be the last PDU associated with the ADU and the second PDU is received before the first threshold time (e.g., before expiry of the timer), the WTRU may select the forwarding configuration with default parameters for transmitting the second PDU in UL. If the second PDU, which may be the last PDU of the ADU, is received by the WTRU after the first threshold time (e.g., before expiry of timer) and before the second time threshold, the WTRU may determine, from the time of reception of the second PDU, the amount of latency reduction or compensation (e.g., time difference between the reception time and the first threshold time) that may be applied for expediting the transmission of the PDU. The WTRU may also determine a suitable forwarding configuration for sending the PDU and/or send an indication to the network for requesting to activate/provide information on forwarding configuration and/or resource grants. The WTRU may then send the second PDU using the determined/selected forwarding configuration, possibly after receiving the activation indication, information related to forwarding configuration to apply (e.g., ID, parameters to apply), and/or resource grants from the network.

If the second PDU, which may be the last PDU of the ADU, is received by the WTRU after the second time threshold, the WTRU may determine the importance/priority indication/marking (e.g., in the PDU header). If the importance/priority indication is greater than a threshold (e.g., where the threshold may be configured by application/higher layer in WTRU), the WTRU may use the forwarding configuration with best effort priority for sending the PDU in UL. Otherwise, if the importance/priority indication is less than the threshold, the WTRU may drop the PDU without sending it. The WTRU may send an indication to the network (e.g., in RRC, MAC CE, control PDU, UCI) when dropping the PDU.

The WTRU may determine to change the priority handling procedure/configuration for addressing a QoS event. The WTRU may change to an alternative priority handling configuration (e.g., LCP configuration at MAC layer) for a certain time duration, possibly when detecting any QoS events, such that any issues related to inability for meeting ADU-level QoS may be mitigated. The QoS events may include a sudden increase in the number of PDUs indicated/marked with high importance/priority.

The WTRU may receive configuration information from the network (e.g., RRC) for changing the priority handling configuration, which may include one or more priority handling configurations (e.g., including at least a first LCP configuration and a second LCP configuration) and/or one or more time durations/periods for controlling the duration of time during which the second LCP configuration may be applied. The first LCP configuration may be initially activated and the second LCP configuration may be deactivated. The first LCP configuration may be used for handling normal data transmission scenarios where the number of PDUs with different importance levels to be mapped from QoS flows and transmitted in UL is within an average range (e.g., above and/or below threshold amount/level). The second LCP configuration may be used when the number of PDUs with different importance/priority levels to be mapped from QoS flows and transmitted in UL is relatively higher (e.g., above a configured threshold value) than the normal scenario. The second LCP configuration may also allow for changing the priority handling procedure/policy from being fair to all forwarding configurations/LCHs that have data/PDUs in the buffers to being biased towards one or more forwarding configurations/LCHs that have data/PDUs with relatively high importance/priority (e.g., above a threshold number).

When receiving the PDUs of an ADU, the WTRU may determine the association of the PDUs to the ADU, possibly in different QoS flows, based on the indications/IDs in the PDU (e.g., ID of ADU in the PDU header). The WTRU may apply the default/first LCP configuration for sending the PDUs mapped to the corresponding forwarding configurations, which may be intended to satisfy ADU-level QoS (e.g., latency, data rate).

When determining/detecting an QoS event, the WTRU may initiate a procedure for changing the LCP configuration to apply for sending the PDUs mapped to the forwarding configurations. The WTRU may determine whether a QoS event will occur based on indications/marking in the PDUs in the QoS flow (e.g., a number of PDUs with high importance values is greater than a threshold).

If a QoS event is detected, the WTRU may change from using the first LCP configuration to the second LCP configuration. The WTRU may also start a timer which may be run for the time duration indicated in the received configuration information, or a time duration estimated based on the duration which may be applied for sending the number of PDUs with high importance values prior to sending other associated PDUs with lower importance values. In an example, the WTRU may determine the time duration for using the second LCP configuration based on any indications from higher layer/application indicating the duration for the QoS event to persist.

The WTRU may send an indication to the network for indicating the request for using/activating the second LCP configuration. The WTRU may also send one or more of the following in the indication: the ID of the LCP configuration requested to be activated or used by the WTRU, the expected time duration for using the second LCP configuration, a distribution of data/number of PDUs with different importance/priority levels, and/or a priority/urgency indication associated with the QoS event, etc. The WTRU may send the indication in AS layer signaling (e.g., RRC message, control PDU associated with any of AS layers, MAC CE or UCI).

The WTRU may receive an indication from the network in AS layer signaling (e.g., RRC, control PDU, MAC CE, DCI) that indicates one or more of the following: a deactivation indication for deactivating the first LCP configuration (ID), an activation/confirmation indication for activating/using the second LCP configuration (ID), and/or one or more validity conditions for using the second LCP configuration (e.g., time period/duration or detection of another QoS event).

After activating the second LCP configuration, the WTRU may send the PDUs with high importance in the corresponding forwarding configuration with the priority/policy/procedure associated with the second LCP configuration. The WTRU may use the second LCP configuration up to the expiry of the timer, which may be set when activating the second LCP configuration. The WTRU may fallback to using the first LCP configuration at the expiry of the timer, for example after deactivating the second LCP configuration. Alternatively, when detecting another QoS event (e.g., the number of high importance PDUs in the QoS flows drops below a threshold), the WTRU may stop the timer, deactivate the second LCP configuration and/or fallback to using the first LCP configuration.

The WTRU may change configuration parameters at PHY and/or MAC layers for transmitting PDUs/ADUs when detecting triggering events/conditions. In examples, the WTRU may modify one or more configuration parameters associated with the PHY layer and/or MAC layer for achieving the expected QoS when transmitting PDUs/ADUs. The WTRU may modify configuration applied for link adaptation, including adjustments/offsets to transmit power, transmission scheme, MCS, coding rate, etc.

In an example, the WTRU may be configured (e.g., via higher layer signaling and/or PHY layer signaling) with one or more transmit power levels, where a transmit power level may be expressed in terms of the ratio over a max transmit power level, possibly on the basis of over a number of resource blocks. When detecting any triggering events/conditions (e.g., as described herein), the WTRU may select and/or use a suitable transmit power level based on the determined expected QoS (e.g., latency, data rate, reliability) for transmitting the PDUs/ADUs. For example, the WTRU may use a higher transmit power level for increasing reliability and/or reducing the number of HARQ retransmissions, when determining a lower latency budget for transmitting the PDUs in UL.

The WTRU, which may be configured with a first and second set of MCS, coding and/or spatial transmission schemes (e.g., MIMO schemes with different layers and/or number of antenna ports), may transition to using the second set of MCS/coding/spatial scheme from the first set when detecting any of the triggering events described herein. For example, the WTRU may use a set of higher order modulation, with low coding rate and higher rank for spatial multiplexing for transmitting PDUs faster (e.g., even when the CSI may not be favorable). The rules for using a suitable set of MCS/coding/spatial schemes when detecting triggering events may be configured in the WTRU by the network via high layer signaling (e.g., RRC).

In an example related to changing intra-WTRU multiplexing behavior, the WTRU may change the rule for multiplexing of PDUs based on different priorities associated with the buffers, including buffers at SDAP, PCDP, RLC, MAC (e.g., LCHs) or any other layers, when detecting any triggering events. In an example related to multiplexing at MAC, if there is overlap for PSSCH resources between a low priority LCH (e.g., carrying eMBB PDUs), a high priority LCH (e.g., carrying URLLC PDUs) and an LCH carrying PDUs with high importance marking, the WTRU may cancel multiplexing of PDUs in low priority LCHs in favor of PDUs with high importance marking and/or high priority for transmission in UL.

The mapping restrictions at the WTRU for mapping between forwarding configurations/LCHs to one or more resources pools/BWPs may be changed/relaxed such that the PDUs in the LCHs may transmitted by accessing suitable resources from restricted resource pools, when detecting any of the triggering events/conditions. For example, the rules associated with the mapping from the forwarding configurations/LCH to resources with a max PSSCH duration may be changed such that the WTRU may access resources, which may not be typically associated with the LCH, for sending the PDUs with high importance values, so long as such PDUs are sent within the max PSSCH duration.

The WTRU may be configured with sublayers/entities at an access stratum for handling delivery of PDUs at the granularity of a PDU set. For example, a PDU set may include one or more PDUs that are associated with a (e.g., one) unit of information generated at an application, and are subject to per-PDU set level quality of service (QOS). In examples, the WTRU may be configured to support one or more (e.g., any) sublayers, entities and/or functionalities at the access stratum for meeting QoS during UL transmissions and/or DL receptions while ensuring the integrity of a PDU set. The configurations supported by the WTRU may refer to any of the layers/sublayers/entities in the access stratum, including but not limited to SDAP, PDCP, RLC, MAC and PHY, for example. A PDU set may refer to an ADU or one or more PDUs in an ADU. Herein, a PDU set and ADU may be used interchangeably when referring to a set of PDUs which may be associated with one or more QoS parameters (e.g. latency, data rate, priority) that may be satisfied on the basis of the PDU set. For example, the latency requirement of a PDU set may be satisfied when the Nth or last PDU in a PDU set consisting of N number of PDUs is transmitted and/or received within a PDU set delay bound (PSDB). For example, the reliability requirement of a PDU set (e.g. PDU set error rate (PSER) may be satisfied when a certain number of PDUs in one or more PDU sets out of the transmitted PDUs are received at a receiving entity (e.g., base station in UL or WTRU in DL) correctly (e.g., without errors), possibly within a latency requirement (e.g., PSDB).

In an example, the WTRU may be configured with one or more SDAP sublayers/entities for ensuring QoS during transmissions and/or receptions on the basis of one or more PDU sets. For enabling this, the WTRU may perform mapping between a QoS flow and a data radio bearer and/or marking of QoS flows in UL and/or DL at an SDAP entity.

The WTRU may perform mapping between a QoS flow and a data radio bearer at an SDAP entity. For example, the WTRU may map one or more PDUs associated with a PDU set in a QoS flow received from high layers/application to one or more configured radio bearers. Such mapping may be performed based on the indications/markings in the PDUs received in a QoS flow and/or mapping rules for mapping from QoS flows to radio bearers configured in the WTRU. For example, the WTRU may identify the start of a PDU set when identifying a new ID/marking or a start of a sequence number (SN) set (e.g., in the header of the PDUs) associated with a PDU set. The WTRU may map one or more (e.g., all) PDUs containing similar IDs/marking/SNs associated with a PDU set to the same radio bearer.

The WTRU may map the PDUs associated with a PDU set in a QoS flow to one or more radio bearers based on QoS indications/markings in the PDUs. For example, the WTRU may map the PDUs in a PDU set to radio bearers based on the priority/importance values indicated in the PDUs (e.g., PDU headers). Such splitting of the PDUs in a PDU set during mapping may be performed for ensuring differentiated QoS and forwarding treatment. When splitting and mapping the PDUs, the WTRU may include an indication in the SDAP header (e.g., IDs, SNs) such that the integrity of the PDU set is preserved during transmission.

The WTRU may perform mapping of PDUs associated with a PDU set to one or more radio bearers which may be configured and/or dedicated for handling the forwarding of PDU sets. Such dedicated radio bearers, which may be identified with a set of IDs, may be the same or different than the radio bearers used for forwarding conventional PDUs that may not be associated with any PDU sets and/or QoS requirements for PDU sets (e.g., PDU set latency bound, PDU set error rate).

The WTRU may perform marking of QoS flows in UL and/or DL at an SDAP entity. For example, the WTRU may include one or more markings (e.g., indications, IDs, SNs) in the PDUs (e.g., PDU headers) associated with a PDU set, possibly for identifying and/or ensuring integrity of the PDU set, during processing at lower layers (e.g., at PDCP, MAC) and/or higher layers (e.g., at NAS). Such markings may be included in an SDAP header, for example. Such markings may be done by the WTRU based on configuration (e.g., RRC) and/or assistance information received from network. In another example, such markings may be done based on detection of indications/markings (e.g., QFI IDs, PDU set ID, SNs, IP header markings) identified from SDUs/PDUs received from higher layers.

In an example, the WTRU may include markings associated with a PDU set based on a reflective QoS approach. In this case, the WTRU may include markings (e.g., QFI, PDU set ID) for PDUs to be transmitted in UL based on the markings identified in the PDUs received in DL via a corresponding radio bearer.

The WTRU may be configured with one or more PDCP sublayers/entities for handling data forwarding on the basis of one or more PDU sets. For enabling this, the WTRU may perform one or more of the following at a PDCP entity: maintenance of PDCP sequence numbers (SNs); reordering and in-order delivery; and/or discarding one or more PDU sets based on a deadline.

The WTRU may perform maintenance of PDCP sequence numbers (SNs) at a PDCP entity. For example, the WTRU may include SNs (e.g., initiating SN, intermediate SN, and/or terminating SN) in one or more PDUs/SDUs received from SDAP/higher layers based on the association of the PDUs to a PDU set. The SNs for a PDU set added by the WTRU may be generated using a similar or different configuration as that used for generating the SNs for conventional PDUs (e.g., PDUs not associated with any PDU sets).

In an example, the SNs for the PDU set added by the WTRU may include a PDU set-level ID/SN (e.g., ID/SN associated with the PDU set) which may be common to one or more (e.g., all) PDUs associated with the PDU set and/or a PDU-level ID/SN. For example, a PDU set comprising of N PDUs may include one or more of the following SNs/IDs: first PDU {set-level SN: 1, PDU-level SN: 1}, second PDU {set-level SN: 1, PDU-level SN 2}, . . . , Nth PDU {set-level SN: 1, PDU-level SN: N}.

The SNs for the PDU set added by the WTRU may ensure in-order delivery of the PDUs in a PDU set. For example, the receiving PDCP entity may reorder the received PDUs in a PDU set (e.g., in increasing order) based on the PDU-level and/or PDU set-level SNs added by the transmitting PDCP entity. Such reordering of the PDUs may be done by the receiving PDCP entity prior to sending the ordered PDUs in a PDU set to the higher layers. The SNs for PDU set may be included in the PDCP header appended to each PDU.

The WTRU may perform reordering and in-order delivery at a PDCP entity. For example, the SNs for the PDU set added by the WTRU may ensure in-order delivery of the PDUs in a PDU set. For example, the receiving PDCP entity may reorder the received PDUs in a PDU set (e.g., in increasing order) based on the PDU-level and/or PDU set-level SNs added by the transmitting PDCP entity. Such reordering of the PDUs may be done by the receiving PDCP entity prior to sending the ordered PDUs in a PDU set to the higher layers.

In an example, the transmitting and/or receiving PDCP entity may be configured with a reordering timer. Such timer may be used for ensuring that the reordering of the PDUs in a PDU set is performed at the receiving PDCP entity before the expiry of the timer. If one or more PDUs in a PDU set are not received before the expiry of the timer, the receiving PDCP entity may perform one or more of the following: i) not send the received PDUs to higher layers and/or discard the received PDUs in the PDU set; ii) send an indication (e.g., in PDCP control PDU, MAC CE, DCI) to the transmitting entity (e.g., PDCP entity, MAC entity) indicating the status (e.g., IDs/SNs) of the received and/or unreceived PDUs; iii) send the received PDUs to higher layers and/or status indication of the received/unreceived PDUs; and/or iv) determine whether to extend the timer and/or send indication to request the delayed/lost PDUs based on the priority/importance IDs/indications of the PDUs within the PDU set.

The WTRU may discard one or more PDU sets based on a deadline at a PDCP entity. In an example, the transmitting and/or receiving PDCP entity may be configured with a discard timer. Such a timer may be used for ensuring that the PDUs in a PDU set are transmitted and/or received within a deadline. For example, the transmitting entity (e.g., transmitting PDCP entity) may start a discard timer upon transmitting one or more PDUs of a PDU set, where the duration of the discard timer may configured to be aligned with the delay bound for transmitting the PDUs of a PDU set. In this case, if the transmitting entity receives a status indication (e.g., ACK/NACK) from the receiving entity (e.g., receiving PDCP entity) before the expiry of the discard timer, the transmitting entity may stop/reset the discard timer and/or transmit the remaining PDUs in the PDU set (e.g., when ACK is received) or retransmit a previous PDU (e.g., when a NACK is received). Otherwise, the transmitting entity may discard the remaining PDUs of the PDU set, for example. In another example, the receiving entity (e.g., receiving PDCP entity) may start a discard timer upon receiving one or more PDUs of a PDU set and/or after transmitting a status indication (e.g., ACK/NACK) to the transmitting entity. In this case, if the receiving entity receives a new PDU in the PDU set and/or a retransmitted PDU in the PDU set before the expiry of the discard timer, the receiving entity may stop/reset the discard timer and transmit the received PDUs to higher layers. Otherwise, the receiving entity may discard the received PDUs of the PDU set.

The WTRU may be configured with one or more MAC sublayers/entities for handling data forwarding on the basis of one or more PDU sets. One or more of the following may be performed by the WTRU at a MAC entity: configuration of LCH(s); mapping between logical channels and transport channels; multiplexing/demultiplexing of MAC SDUs/PDUs; scheduling information reporting; error correction through HARQ; priority handling between logical channels of a WTRU (e.g., via LCP); and/or priority handling between overlapping resources.

The WTRU may perform configuration of LCHs at a MAC entity. In an example, the PDUs of a PDU set may be configured to be received from higher layers (e.g., RLC layer, PDCP layer) into one or more LCHs. The LCH parameters (e.g., priority, BSD, PBR, LCH mapping restrictions) may be applied on the basis of per PDU set. For example, one or more of the following may be configured for the different LCH parameters for handling PDU set(s): the PDU set priority (e.g., the same or different priority value may be applied for one or more (e.g., all) PDUs in a PDU set); PDU set maxPUSCH-duration (e.g., the max PUSCH duration may correspond to the total duration for transmitting one or more (e.g., all) PDUs in PDU set); PDU set BSD (e.g., the BSD may correspond to the total BSD used when mapping/multiplexing one or more (e.g., all) PDUs in the PDU set); PDU set PBR (e.g., the PBR may correspond to the total PBR used when mapping/multiplexing one or more (e.g., all) PDUs in the PDU set); and/or one or more PDU set LCH mapping restrictions (e.g., the same or different LCH mapping restrictions may be applied for one or more (e.g., all) PDUs in a PDU set).

The WTRU may perform mapping between logical channels and transport channels at a MAC entity. For example, the WTRU may be configured with mapping configurations/rules/restrictions to perform mapping of PDUs associated with a PDU set in one or more logical channels to one or more transport channels. In an example, the WTRU may perform 1-to-1 mapping between a logical channel comprising of PDUs of a PDU set to a (e.g., one) transport channel based on configured mapping rules. In another example, the WTRU may be configured with mapping rules/restrictions to perform N-to-1, 1-to-M or N-to-M mapping of PDUs associated with PDU sets in one or more LCHs to one or more transport channels. For example, when configured with 1-to-M mapping, the WTRU may map the PDUs of a PDU set in one LCH to multiple transport channels, possibly based on total payload or PDU count thresholds associated with the transport channel. In this case, a (e.g., each) transport channel may be configured with threshold values corresponding to allowed or available resource grant size. In another example, when configured with N-to-1 mapping, the WTRU may map the PDUs of a PDU set that are received in multiple LCHs to a (e.g., one) transport channel, possibly based on markings/indications of the PDU set ID in the PDUs. Such mapping may be performed so that one or more (e.g., all) PDUs of the PDU set are transmitted in the same transport channel via one or more transport blocks.

The WTRU may perform multiplexing/demultiplexing of MAC SDUs/PDUs at a MAC entity. For example, the WTRU may be configured with rules/restrictions for assisting with multiplexing/demultiplexing one or more PDUs of a PDU set, possibly when mapping between the PDUs in logical channels to transport block (TBs) in transport channels. For example, the WTRU may be configured with multiplexing rules indicating whether the PDUs associated with a PDU set are multiplexed into the same or different transport blocks based on the type of the PDU set, total payload size of PDU set, number of PDUs in PDU set, and/or QoS requirements of PDU set (e.g., latency, error rate, bit rate, priority), etc.

The WTRU may perform scheduling information reporting at a MAC entity. For example, the WTRU may trigger the transmission of an SR for requesting PUSCH resources for sending BSR (e.g., in new or regular MAC CE) when a new PDU set, comprising of one or more PDUs, is received in an LCH (e.g., in a buffer of the LCH). The WTRU may transmit SR when there are no available PUSCH resources, possibly corresponding to the LCH/LCG that received the PDU set or corresponding to other LCHs/LCGs with lower priority, for example. The new SR associated with PDU set may be different than the conventional SR, which may not be associated with any PDU sets.

In an example, the WTRU may trigger the transmission of a BSR when a new PDU set, comprising one or more PDUs, is received in an LCH (e.g. a buffer of the LCH). In this case, the WTRU may transmit a BSR when other LCHs have empty buffers and/or when the LCH that receives the new PDU set has higher priority than other LCHs, which may have previously triggered transmission of SR/BSR, for example due to arrival of data. The WTRU may transmit BSR on the basis of per-LCG, which may be associated with the LCH on which the new PDU set is received. In an example, the WTRU may transmit a new BSR after arrival of the first and/or the last PDU associated with a PDU set in the LCH buffer. For example, the WTRU may start a counter upon receiving the first PDU associated with a PDU set and/or may transmit the new BSR when the counter value is greater or less than a preconfigured threshold value. In another example, the WTRU may be preconfigured with a threshold value corresponding to the total payload size of a PDU set (e.g., sum of payload of one or more PDUs in a PDU set). The WTRU may transmit the new BSR when the total payload size of the PDU set is greater or less than the preconfigured threshold value.

The WTRU may transmit BSR when a first PDU associated with a PDU set is received, where the BSR may indicate the expected payload of the PDU set and/or the number of PDUs expected in the PDU set. The WTRU may determine the expected payload and/or the number of PDUs in the PDU set based on the markings/indications in the first PDU (e.g., PDU header), possibly indicating the type of PDU set (e.g., I/P/B-frame) and/or association info possibly configured in the WTRU indicating the mapping between the type of PDU and expected payload size/number of PDUs.

In an example, the WTRU may transmit different types of BSRs associated with requesting dynamic grant(s) for UL transmissions of the PDUs in the PDU set. Such BSR types may include event triggered/regular BSR (e.g., transmitted by WTRU when PDUs of PDU set arrive in LCH buffer) or periodic BSR (e.g., transmitted by WTRU periodically to request UL grant for periodic transmission of PDUs in PDU set). In the case of periodic BSR, the periodicity applied for transmitting the BSR may be configured such that it may be aligned with the periodicity of the PDU set arrival from higher layers (e.g., frame rate used by codec or frame rate of pose data). The WTRU may send an indication to the network (e.g., in RRC, MAC CE, UCI) for indicating the arrival rate of data (e.g., frame rate) during initial configuration or when a change in the arrival rate is detected, such that the WTRU is configured with periodic BSR with a particular periodicity value.

In an example, the WTRU may trigger the transmission of SR and/or BSR (e.g., preemptive BSR) based on expected arrival time and/or expected payload sizes of PDUs in a PDU set. For example, the WTRU may be aware of, and/or configured with, the information on the arrival time of the PDUs of a PDU set (e.g., from higher layers). Such arrival time may be associated with the arrival of periodic data, where the periodicity of the data may be aligned with the frame rate applied at higher layers/application/codec. Based on the estimation of the arrival time of the PDUs, the WTRU may trigger the transmission of SR/BSR, possibly preemptively for requesting the UL grants for transmitting of PDUs after the PDUs expected to be received. The WTRU may also estimate/predict the payload size of the expected PDUs in a PDU set based on tracking of the previously received/transmitted PDUs and/or based on marking/indications in the PDUs (e.g., in PDU headers). For enabling the triggering of such SR/BSR, which may be transmitted preemptively prior to the arrival of data, the WTRU may be configured with one or more threshold values associated with estimation/prediction of the data arrival times and/or payload sizes of the expected data. The WTRU may trigger SR/BSR when the estimated arrival time is higher or less than a threshold value or within a range. The WTRU may trigger SR/BSR when the estimated payload size of the expected PDUs in PDU set is higher or less than a threshold value or within a range.

In an example, for enabling the WTRU to transmit one or more PDUs of a PDU set, possibly with high total payload size and/or low latency, the WTRU may trigger the transmission of multiple SR/BSRs for receiving multiple dynamic grants. The WTRU may perform transmissions of PDUs in PDU sets in UL, possibly using multiple TBs, which may be transmitted consecutively or within low latency. Such transmissions via multiple TBs may be performed based on the allocation of multiple dynamic grants. In this case, when receiving the PDUs of a PDU set in the buffers of one or more LCHs and the total payload size or PDU count is higher than a first threshold value, the WTRU may transmit a first BSR. The WTRU may then transmit a second BSR, for example when the total payload or PDU count is higher than a second threshold value. The first threshold value may be associated with a default/average value corresponding to the total payload size or PDU count, and the second threshold value may be associated with higher than average or excess payload size, or excess PDU count, which may account for variable PDUs in the PDU set. The WTRU may receive the resource allocation in one or more dynamic grants, where a first dynamic grant may be used for transmitting the default/average number of PDU and a second dynamic grant may be used for transmitting the excess PDUs.

The WTRU may perform error correction through HARQ at a MAC entity. For example, the WTRU may be configured with one or more HARQ entities (e.g., per cell or per carrier), where one or more (e.g., each) HARQ entities may handle one or more HARQ processes associated with transmissions and/or retransmissions of PDUs associated with PDU sets. The HARQ processes configured for handling (re) transmissions of PDUs associated with one or more PDU sets may be identified with a HARQ process ID, which may be the same or different than the HARQ process IDs associated with regular PDUs (e.g., which may not be part of any PDU set(s)). A HARQ process may be associated with the (re) transmission of one or more PDU sets, in which case the ID of the HARQ process may be associated with the ID of the PDU set, and possibly used (e.g., in PDU headers or MAC CEs) during the transmission of the PDUs.

When the WTRU is configured with a HARQ entity at the transmitting entity (e.g., transmitting MAC entity at WTRU) for handling (re) transmissions of PDU sets via a HARQ process, the corresponding HARQ entity at the receiving entity (e.g., receiving MAC entity at gNB) may transmit a status indication (e.g., ACK/NACK) to the transmitting entity on the basis of one or more PDUs and/or on the basis of a PDU set. The receiving entity may send an ACK message, possibly along with a PDU set ID and/or HARQ process ID, to the transmitting entity (e.g., only) when one or more (e.g., all) PDUs of a PDU set are successfully received/decoded at the receiving entity. Otherwise, when one or more PDUs are not received/decoded successfully, the receiving entity may transit a NACK message, possibly along with the PDU ID, PDU set ID and/or HARQ process ID, to the transmitting entity. The receiving entity may transmit a NACK message when one or more PDUs of a PDU set are not correctly received/decoded before the expiry of a configured timer.

In an example, when the WTRU is configured with HARQ on a per-PDU set basis, the number of retransmissions allowed per PDU of a PDU set may be configured based on a PDU set delay bound (PSDB) and/or PDU set error rate (PSER) associated with the PDU set. For example, the number of HARQ retransmissions that may be allowed per PDU in a PDU set may be determined as PSDB divided by the product of latency per retransmission and number of PDUs per PDU set.

In another example, the number of retransmissions allowed may depend on the type of the PDU in a PDU set and/or the PDU set. For example, for a PDU set associated with an I-frame, the WTRU may be configured with K1 number of allowed retransmissions, and for a PDU set associated with a P/B-frame, the WTRU may be configured with K2 number of allowed retransmissions, where K2 may be greater than, equal to, or lower than K1. For example, within a PDU set, the PDUs with importance/priority values above a threshold may be transmitted with N1 number of allowed retransmissions, and PDUs with importance/priority values below a threshold may be transmitted with N₂ number of allowed retransmissions. The one or more PDUs transmitted, including the first PDU and the second PDU of a PDU set, may be transmitted with M1 number of retransmissions. Similarly, the one or more PDUs transmitted, including the third PDU and the fourth PDU of a PDU set, may be transmitted with M2 number of retransmissions, where M1 and M2 values may depend on, for example, the importance/priority values associated with the PDUs of the PDU set.

The WTRU may perform priority handling between logical channels of a WTRU (e.g., via LCP) at a MAC entity. The WTRU may be configured to ensure a PDU set-level delay bound (PSDB) during transmission of one or more PDUs of a PDU set by performing a priority handling procedure via LCP. For a PDU set comprising of N PDUs, the WTRU may transmit the N PDUs within a configured PSDB value.

In an example, the WTRU may be configured by the network with a per-PDU PDB value and/or with a priority value associated with the LCH carrying the PDU. The per-PDU PDB value may be determined by dividing the PSDB by the number of PDUs in the PDU set. Such per-PDU PDB value and/or associated priority value may enable the N PDUs in a PDU set to be transmitted within the PSDB value. For enabling such transmission within the PSDB, the WTRU may indicate to the gNB information on the number of PDUs per PDU set. The information on the number of PDUs may be determined and/or indicated to network by the WTRU semi-statically (e.g., in RRC) and/or dynamically (e.g., in RRC, MAC CE, DCI) based on detection of marking/indications in the PDUs of the PDU set, higher layer configuration/indication (e.g., whether PDU set corresponds to I-frame/P-frame), etc. Based on such information, the WTRU may receive the configuration information or activation/deactivation indications from the network on the configuration parameters of the LCHs (e.g., priority, PBR, BSD, LCH restrictions) which may be used for ensuring the PSDB of the PDU set.

The WTRU may be preconfigured with one or more LCHs with different LCH parameters (e.g., priority, PBR, BSR, LCH mapping restrictions). The WTRU may also be configured with one or more threshold values, possibly associated with PDU count. The WTRU may transmit an indication to the network (e.g., in MAC CE, SR/BSR) when the number of PDUs in a PDU set received from a higher layer is greater than or less than the PDU count threshold. The WTRU may receive an indication from network indicating the activation/deactivation of the preconfigured LCH configurations that may be used for transmitting the PDUs in the PDU set within the PSDB.

The WTRU may be configured with rules/restrictions indicating which of the LCH configurations is used for transmitting the PDUs in a PDU set for one or more PDU count values and/or for different PSDB values. In this case, the WTRU may use a first set of LCHs when the PDU count in a PDU set is less than or greater than a first PDU count threshold or within a first PDU count range. Similarly, the WTRU may use a second set of LCHs when the PDU count in a PDU set is less than or greater than a second PDU count threshold or within a second PDU count range.

The WTRU may be configured to track the remaining latency (e.g., difference between PSDB and actual latency) for sending one or more remaining PDUs in a PDU set. The WTRU may select one or more suitable LCHs with preconfigured parameters (e.g., priority, PBR) such that the remaining PDUs are transmitted within the PSDU. In this case, the WTRU may be configured with one or more timers which may be set after transmitting the first PDU of a PDU set. The WTRU may then perform a selection of a suitable LCH when the number of remaining PDUs in the PDU set is greater than a threshold value upon expiry of the timer.

The WTRU may perform priority handling between overlapping resources at a MAC entity. The WTRU may be configured with one or more resource configurations including configured grants, bandwidth parts, carriers, cells, etc. Such resource configurations may be associated with different priority values. The WTRU may determine whether to use the one or more resource configurations for transmitting PDUs in a PDU set based on identification of the priority values of the resource configurations that matches with the priority/importance values of the PDUs and/or PDU sets. For example, the WTRU may use a first resource configuration when the priority value associated with the PDU set is greater than a threshold value, and a second resource configuration when the priority value associated with the PDU set is less than the threshold value. When the same resources or resource configurations assigned for one or more PDUs that are not part of any PDU sets overlap with one or more PDUs of a PDU set, the resources or resource configurations may be used for whichever PDUs have a greater priority.

In an example, the WTRU may be configured with one or more mapping restrictions indicating whether the PDUs of a PDU set of an LCH may be mapped to one or more configured grant (CG) configurations. In this case, an LCH carrying PDUs of PDU sets may be initially configured with a default CG and/or a set of alternative CG configurations. The different CG configurations may be associated with different priority values. When the PDU set received in the LCH has a priority value below than a threshold priority value, the WTRU may use the default CG. When the priority value of the PDU set is above the threshold priority value, the WTRU may use a second CG configuration, which may be selected from the set of alternative configurations based on the associated priority values.

The WTRU may change CG/SPS configuration parameters and/or select a CG/SPS configuration for (re) aligning with data transmission/reception. A WTRU configured with one or more configured grant (CG) and/or semi-persistent grant (SPS) configurations may periodically change the parameters associated with a CG/SPS configuration based on a realignment periodicity value for realigning with periodic data transmission/reception. Alternatively, the WTRU, which may be preconfigured with one or more CG configurations (e.g., for UL transmission) and/or SPS configurations (e.g., for DL reception), may periodically select a new CG/SPS configuration based on the realignment periodicity value.

The WTRU may be configured by the network with default/initial CG/SPS configuration(s) and/or a default set of parameters associated with a CG/SPS configuration, which the WTRU may use initially upon receiving the configurations from the network. The WTRU may also be configured with a set of alternative CG/SPS configurations, parameters and/or parameter values to which the WTRU may change periodically based on a configured realignment periodicity value. Any of the CG/SPS configurations or CG/SPS parameters may be used by the WTRU for transmitting data in UL or receiving data in DL in one or more data flows.

The parameters associated with a CG/SPS configurations configured in the WTRU, for example, may include one or more of the following: an offset start time slot for starting the use of CG/SPS resources, a periodicity of CG/SPS resources in the corresponding CG/SPS configurations, an on/active time duration associated with CG/SPS resources (e.g., number of consecutive time/frequency resources the WTRU may use), and/or a stop time slot for stopping the use of CG/SPS resources.

When changing any of the CG/SPS parameters or selecting a new CG/SPS configuration, the WTRU may send an indication to network (e.g., via RRC message, MAC CE, UCI) for indicating the change in parameter (e.g., ID and/or value of CG/SPS parameter) and/or change in configuration (e.g., ID of CG/SPS configuration). The WTRU may use the corresponding updated parameters or new CG/SPS configuration upon receiving a confirmation indication from network and/or after expiry of a configured time duration. If a rejection indication is received from the network, the WTRU may fallback to using the default/initial CG/SPS configuration and/or a default set of parameters.

In an example, the parameters of the CG/SPS configuration may be associated with a frame rate corresponding to the data expected to be transmitted/received by the WTRU. For a video data with frame rate of 60 frames per second (fps), the WTRU may be expected to transmit one or more PDUs in a PDU set associated with the frame in UL periodically with periodicity value of 1/60 or 16.66 ms. For transmitting such video data, the WTRU may be configured with one or more CG configurations with periodicity value of 16 ms and 2 ms for on/active time duration, for example. When using such CG configuration, after several time slots/occasions in which the WTRU transmits the data in UL during the on/active time duration, the CG configuration may become misaligned with respect to the frame rate, possibly due to the non-integer periodicity values corresponding to the frame rate. In this case, the WTRU may be configured with a realignment periodicity value of, for example, 64 ms so that the WTRU may periodically change one or more (e.g., any) of the parameters (e.g., offset start time slot or the on/active time duration) and/or select a new CG configuration. The configured realignment periodicity applied by the WTRU may be based on assistance information, such as the frame rate, provided by the WTRU to the network. The WTRU may be configured with the CG/SPS configurations and/or the realignment periodicity based on the assistance information (e.g., frame rate) provided by the WTRU to the network.

The WTRU may change the parameters associated with a CG/SPS configuration or select a new CG/SPS configuration when detecting a triggering event, which may be one or more of the following: connectivity/session (re) configuration; reception of a higher layer/application layer indication; changing/updating data flows per application; a measurement of jitter; a measurement of a radio link; a detection of a change in movement of the WTRU; and/or a change in power-saving configuration.

The WTRU may change the parameters associated with a CG/SPS configuration or select a new CG/SPS configuration when detecting a connectivity/session (re) configuration. For example, the WTRU may change the parameters when receiving/transmitting any signaling messages associated with (re) configuration of RRC connection, RRC state, PDU session, and/or application layer session, and/or when changing an RRC state from RRC CONNECTED to RRC INACTIVE/IDLE or vice-versa.

The WTRU may change the parameters associated with a CG/SPS configuration or select a new CG/SPS configuration when detecting reception of a higher layer/application layer indication. For example, the WTRU may change the parameters when receiving an indication from higher layers, from PDUs (e.g., marking in header) or from network indicating any of the following changes in the upcoming data which may be transmitted/received using any of CG/SPS configuration: data type (e.g., upcoming frame changes from P/B frame to I-frame); failed higher layer frame (e.g., the application layer has failed to decode an I-frame); traffic characteristics (e.g., number of PDUs in a PDU set is expected to be above/below a threshold value, PDB or PSDB is expected to be above/below a threshold, PER or PSER is expected to be above/below a threshold, frame rate increases/decreases above/below a threshold, etc.); priority of data (e.g., priority value of PDUs or PDU sets is expected to be above/below a threshold; and/or QFI or any QoS indication/marking (e.g., QFI value is expected to be greater/lower than a threshold value).

The WTRU may change the parameters associated with a CG/SPS configuration or select a new CG/SPS configuration when detecting changing/updating data flows per application. For example, the WTRU may change the parameters when adding one or more new flows and/or when releasing existing flows associated with an application.

The WTRU may change the parameters associated with a CG/SPS configuration or select a new CG/SPS configuration when detecting a measurement of jitter. For example, the WTRU may change the parameters when the measured jitter value (e.g., difference between the expected time slot when data is expected to be received and actual time slot when data is actually received) in one or more data flows is above/below a threshold value.

The WTRU may change the parameters associated with a CG/SPS configuration or select a new CG/SPS configuration when detecting a measurement of a radio link. For example, the WTRU may change the parameters when the RSRP, RSRQ, and RSSI measurements of the signals, channels, beams, carriers, links, etc., which may be associated with the one or more data flows transmitted/received by WTRU, are above/below respective threshold values.

The WTRU may change the parameters associated with a CG/SPS configuration or select a new CG/SPS configuration when detecting a change in movement of the WTRU. For example, the WTRU may change the parameters when pose/positioning measurements (e.g., location information, pose in 6DoF) are above/below pose/location threshold values.

The WTRU may change the parameters associated with a CG/SPS configuration or select a new CG/SPS configuration when detecting a change in power-saving configuration. For example, the WTRU may change the parameters when changing one or more (e.g., any) of the parameters and/or configurations associated with CDRX/DRX (e.g., cycle duration, on time, inactive time, etc.).

The WTRU may change the parameters of a CG/SPS configuration or change to a new CG/SPS configuration when detecting any changes to the motion-to-photon (MTP) or RTT latency. Such RTT latency is typically measured between the transmission of UL data during an active time of an CG configuration and the reception of DL data, possibly associated with UL data, during an active time of an SPS configuration.

The WTRU may be configured by the network with one or more CG/SPS configurations based on the statistical information (e.g., average, standard deviation, minimum, maximum) related to RTT latency provided by the WTRU in assistance information to the serving base station in RAN, for example. The WTRU may also be configured with one or more RTT threshold values (e.g., corresponding to maximum or minimum difference in latency from the average/expected RTT latency value) associated with CG/SPS configuration, which may indicate the validity for using the CG/SPS configuration when transmitting and receiving data within the RTT latency.

When the WTRU is configured with CG/SPS configurations, the WTRU may determine the RTT latency based on the measurement of the time difference between the transmission and reception of associated data or based on another indication received from a higher layer. The WTRU may compare the measured RTT latency with respect to a configured threshold value for determining whether the CG/SPS configurations are valid for transmitting/receiving data. When the WTRU determines that the RTT latency is above/below a configured RTT threshold value, the WTRU may send an indication/request to the network to change the parameters of the CG/SPS configurations or select a new CG/SPS configuration such that the data transmission/reception are aligned with the determined RTT latency.

The WTRU may be configured to handle different types of PDU sets. For example, the WTRU may be configured to perform transmissions and/or receptions by using one or more types of forwarding configurations and/or resource configurations based on the type of PDU set. The types of PDU sets may be differentiated based on one or more of the following: the type of application/media data; the PDU set size; QoS information; importance/priority information; traffic characteristics; intra-PDU set association/dependence; and/or the type of forwarding treatment expected.

The types of PDU sets may be differentiated based on the type of application/media data. For example, I-frame data, P-frame data, audio data, haptics data, etc. may correspond to different types of PDU set.

The types of PDU sets may be differentiated based on the PDU set size. For example, the PDU sets may be differentiated based on payload size characteristics, including total size, mean size, minimum and/or maximum size (e.g., in units of bits/bytes). Alternatively, the PDU set may be differentiated based on the number of PDUs per PDU set.

The types of PDU sets may be differentiated based on QoS information. For example, the PDU sets may be differentiated based on the PDU set level QoS, including PDU set level delay bound (PSDB), PDU set level error rate (PSER), PDU set throughput, etc.

The types of PDU sets may be differentiated based on importance/priority information. For example, the PDU sets may be differentiated based on the PDU set level importance/priority value. The PDU set level importance/priority value may correspond to one or more (e.g., all) PDUs in the PDU set (e.g., all PDUs have the same priority value and/or the priority value of each PDU is the same/similar as the priority value of PDU set). The importance/priority value of a subset of the PDUs may be different than the PDU set-level importance/priority value (e.g., some PDUs of the PDU set may have different importance/priority value compared to other PDUs).

The types of PDU sets may be differentiated based on traffic characteristics. For example, the PDU sets may be differentiated based on whether the associated traffic characteristic is aperiodic, semi-persistent or periodic. For a PDU set with periodic characteristic (e.g., corresponding to frame rate), different PDUs sets (e.g., which may be associated with different flows) may have different periodicity values.

The types of PDU sets may be differentiated based on intra-PDU set association/dependence. For example, the PDU sets may be differentiated based on the intra-PDU set association indication/information that may be carried by one or more PDUs of the PDU set. Some PDUs in a PDU set may carry the start and/or end indication, indicating the first and last PDU of the PDU set. For example, some PDUs in a PDU set may indicate a sequence number corresponding to the order at which the PDUs are generated and/or intended to be delivered during transmission. For some PDU sets, the first subset of one or more PDUs of the PDU set may contain information corresponding to the remaining PDUs in the PDU set. Such information may include the number of PDUs in the PDU set, the size of the PDU set (e.g., total payload size), the latency for delivering the PDU set, and/or the distribution of importance/priority of PDUs in the PDU set (e.g., number of PDUs with high/low priority), etc.

The types of PDU sets may be differentiated based on the type of forwarding treatment expected. For example, the WTRU may be configured to differentiate between at least a first type of PDU set and a second type of PDU set when determining/selecting the type of forwarding treatment to apply. The first type of PDU set (e.g., type 1) may correspond to the case where one or more (e.g., all) PDUs associated with a PDU set are expected to be delivered in UL/DL within the QoS (e.g., PSDB, PSER). In this case, one or more (e.g., all) PDUs in the PDU set may have similar importance/priority values. The second type of PDU set (e.g., type 2) may correspond to the case where one or more PDUs associated with a PDU set are associated with different QoS and/or are delivered using a different forwarding treatment compared to the other PDUs in the PDU set. For example, when one or more high importance/priority PDUs in a PDU set are received within the associated QoS, no adverse impact to the application performance may be observed even when some of the other PDUs are delayed or lost.

When the WTRU is configured for transmitting and/or receiving different types of PDU sets (e.g., type 1, type 2), one or more of the procedures and/or techniques applicable at different protocol stack layers, as described herein, may be applied. For example, the functionality/procedures that may be selected/determined and/or used by WTRU at the SDAP sublayer (e.g., mapping between QoS flows to radio bearers), PDCP sublayer (e.g., discarding PDU set based on deadline), RLC sublayer, MAC sublayer (e.g., multiplexing, scheduling) and/or PHY sublayer may be dependent on the type of PDU set (e.g., type 1, type 2) transmitted/received by the WTRU.

The WTRU may be configured with LCP restrictions for handling PDU sets. For example, the WTRU may be configured with LCP restrictions when performing transmissions of PDU sets. The LCP restrictions may apply to the one or more LCHs to which the PDUs of a PDU set are mapped.

The LCHs which buffer and/or carry the PDUs of a PDU set may correspond and/or be referred to as a PDU set LCH group (PSLG). In an example, when the PSLG is configured with a single LCH, one or more (e.g., all) PDUs in a PDU set may be mapped to the same LCH or same radio bearer. In another example, the PDUs in a PDU set may be mapped to different LCHs associated with PSLG, possibly based on the priority/importance of the PDUs (e.g., based on markings in PDU header). Such mapping may be done by the PDCP entity/sublayer or SDAP entity/sublayer.

The one or more PSLGs configured in the WTRU may be associated with different identifiers/IDs. Such configurations associated with the PSLG may be applied when triggering SR and/or BSR. For example, for triggering an SR and/or BSR, the WTRU may be configured with a threshold value (e.g., payload, PSDB, deadline) corresponding to the LCHs in the PSLG. In this case, when the total payload of the PDUs/PDU sets in the LCHs associated with the PSLG is above/below one or more threshold values, the WTRU may trigger the SR and/or BSR, for example. The SR and/or BSR triggered by the WTRU may carry the PSLG ID implicitly or explicitly.

A PDU set consisting of a first and second PDU may be mapped to first and second LCHs. The first and second LCHs may be grouped into a PSLG. When the WTRU is configured with PSLG level LCP restrictions, the LCP restrictions and/or rules that may apply to the first LCH (e.g., during scheduling and/or multiplexing) may also apply to the second LCH belonging to the PSLG. The WTRU may also be configured with per-LCH level LCP restrictions, which may be the same or different than the PSLG level LCP restrictions.

The LCP restrictions may be configured on the basis of whether a type 1 PDU set (e.g., all PDUs in PDU set are of equal importance) or a type 2 PDU set (e.g., some PDUs are more important than others) may be handled by the WTRU. For example, for a type 1 PDU set, the one or more LCHs associated with an PSLG may be associated with the same or similar LCP restrictions/rules that the WTRU may be expected to follow during scheduling and/or multiplexing. For a type 2 PDU set, some LCHs associated with the PSLG may be configured with different LCP restrictions/rules compared to the other LCHs in the PSLG.

The LCP restrictions, associated with PSLG and/or LCHs carrying PDUs of PDU sets, may include one or more of the following: an allowed set of subcarrier spacings (SCS); a maximum PUSCH duration/length; a set of serving cells; a number of PUSCH slots per PSLG; one or more priority values; one or more SR resources; and/or one or more resource configurations.

The LCP restrictions, associated with PSLG and/or LCHs carrying PDUs of PDU sets, may include an allowed set of subcarrier spacings (SCS). For example, the one or more LCHs in a PSLG may be allowed to use a set of one or more SCSes, such as 15 khz, 30 khz, 60 khz, 120 khz, etc. Such SCS values may be associated with the BWPs, carriers, frequency bands, etc. to which the PSLG may be restricted to use. When one or more LCHs in the PSLG are configured with the same or different SCS values, the PDUs in a PDU set may be allowed to use the corresponding set of SCS values during transmissions.

The LCP restrictions, associated with PSLG and/or LCHs carrying PDUs of PDU sets, may include a maximum PUSCH duration/length. For example, when configured with max PUSCH duration for one or more LCHs in an PSLG and/or PUSCH resources, the WTRU may schedule the PDUs in a PDU set up to the max number of slots and/or maximum number of OFDM symbols associated with the PUSCH duration/length, possibly in a (e.g., one) PUSCH occasion. Other PDUs or PDU sets (e.g., non-XR traffic) that may tolerate higher latency values during UL transmission may not be scheduled by the WTRU along with the PDUs/PDU sets (e.g., XR traffic) that use the PUSCH resources configured with the max PUSCH duration/length.

The LCP restrictions, associated with PSLG and/or LCHs carrying PDUs of PDU sets, may include a set of serving cells. For example, when configured with a set of serving cells for the one or more LCHs in a PSLG, the PDUs/PDU sets associated with the LCHs/PSLGs may use any of the one or more component carriers, cells, BWPs, coresets, links, etc. during UL transmissions. Other PDUs/PDU sets which are not associated with the LCHs/PSLGs may not be allowed to use the set of serving cells.

The LCP restrictions, associated with PSLG and/or LCHs carrying PDUs of PDU sets, may include a number of PUSCH slots per PSLG. For example, the WTRU may be configured with a number of PUSCH slots per PSLG. Such PUSCH slots may correspond to one or more resource configurations, including configured grant (CG) and/or dynamic grant (DG), for example. The WTRU may use a first PUSCH slot in a first CG and a second PUSCH slot in a second CG. Similarly, the WTRU may use a first and second PUSCH slot in one CG configuration.

The LCP restrictions, associated with PSLG and/or LCHs carrying PDUs of PDU sets, may include one or more priority values. For example, the WTRU may be configured with one or more priority values for the LCHs/PSLGs that the WTRU may be allowed to use/change during transmission of PDUs/PDU sets.

The LCP restrictions, associated with PSLG and/or LCHs carrying PDUs of PDU sets, may include one or more SR resources. For example, the WTRU may be configured with one or more configurations associated with a scheduling request (SR), which may be restricted to be used for the one or more LCHs/PSLGs. Such SR configurations may include SR resources (e.g., time-frequency resources, grant size, etc.), periodicity values, semi-persistent duration (e.g., start/end time slot), etc. In an example, the WTRU may be allowed to use the SR configuration (e.g., resources, periodicity) associated with an LCH when one or more (e.g., any) of the PDUs of a PDU set are mapped to the LCH. For example, for a set of LCHs in a PSLG which may be associated to transmit a PDU set with low latency and high throughput QoS, the SR resources may be configured to be available with high periodicity value.

The LCP restrictions, associated with PSLG and/or LCHs carrying PDUs of PDU sets, may include one or more resource configurations. For example, the WTRU may be configured with one or more resource configurations, including CG and/or DG configurations, that may be restricted to some LCHs and/or PSLGs. The PDUs of a PDU set mapped to the LCHs/PSLG may use one or more (e.g., any) of the resource configurations restricted/allowed for the LCHs/PSLGs. In an example, a first LCH may be restricted to a first and second CG configuration, and a second LCH may be restricted to the second CG configuration. A PDU set mapped to the first LCH may use the resources in the first and second CG configuration, for example. Other PDUs mapped to the second LCH may share the resources in the second CG configuration with the PDU mapped from the first LCH.

In an example, the LCHs of a PSLG may be restricted to use one or more CG configurations which may be configured with a low periodicity, low CG cycle duration, and/or high number of PUSCH slots per CG occasion that may be associated with a PSDB of the PDU set. Given the restrictions, other LCHs which may have PDUs that can tolerate longer delay (e.g., longer PUSCH duration) may not be multiplexed with the PDUs of the PDU set that require meeting the low PSDB value, for example when using the CG configurations.

In an example, the LCP restrictions may be associated and/or configured with certain conditions/criteria indicating the scenarios when the restrictions may apply or when the restrictions may be exempted/relaxed. In this case, when the restrictions are relaxed due to meeting some conditions/criteria, the WTRU may be allowed to use certain non-default configurations. Such non-default configurations may include configurations/resources associated with other LCHs, possibly including those not associated with the PSLG.

For example, when configured with LCP restrictions, the WTRU may be configured with conditions associated with one or more of the following: a channel quality, a timer value, and/or a QoS.

When configured with LCP restrictions, the WTRU may be configured with conditions associated with a channel quality. For example, the WTRU may be allowed to use a non-default resource configuration associated with one or more LCHs/PSLG when the channel/link quality (e.g., RSRP measurement) meets a measurement criteria (e.g., above/below one or more threshold values).

When configured with LCP restrictions, the WTRU may be configured with conditions associated with a timer value. For example, the WTRU may be allowed to use non-default parameters (e.g., SCS, PUSCH duration) and/or resource configuration (e.g., CG, DG) so long as a configured timer is set and/or running. When the timer expires, the WTRU may be expected to fall back to a default restriction/configuration.

When configured with LCP restrictions, the WTRU may be configured with conditions associated with a QoS. For example, the WTRU may be allowed to use non-default configurations and/or resources, when one or more PDUs of a PDU set may be determined to not meet the delay bound (e.g., PSDB) or approaching close to a deadline (e.g., above/below a deadline threshold) when transmitting using the restricted default configurations/resources.

A WTRU may be configured with one or more logical channel groups (LCGs) that may be intended for handling any of multiplexing, scheduling, and/or transmission of one or more PDU sets. An LCG may be associated with one or more logical channels (LCHs), where an (e.g., each) LCH may be associated with different parameters including priority, prioritized bit rate (PBR), and/or bucket size duration (BSD), for example. The one or more LCGs configured for handling PDU sets may be associated with one or more IDs/indexes. When configured with LCGs intended for handling PDU sets, the WTRU may transmit an indication (e.g., in BSR, new/enhanced BSR) to the base station when receiving data (e.g., from higher layers) in any of the LCH buffers associated with LCG. The WTRU may indicate, in the indication, the payload size info (e.g., total payload of the PDUs) associated with the one or more PDUs of the PDU set. In an example, the WTRU may be configured with one or more LCGs, where an (e.g., each) LCG may be associated with a different number and/or combination of LCHs. The WTRU may select the most suitable LCG for performing any of multiplexing, scheduling and transmitting data in UL based on the data and/or traffic pattern info (e.g., total size of payload, priority, reliability, latency bound) associated with the PDU sets received from higher layers. For example, a WTRU may be configured with an LCG1 associated with LCHs 1, 2 and 3 and an LCG2 associated with LCHs 2, 3 and 4. When the WTRU receives data associated with a PDU set or data burst (e.g., from higher layers or application) and/or the data is mapped to LCHs 1, 2, 3, the WTRU may select LCG1 when sending an indication (e.g., BSR or new/enhanced BSR) to the base station. The WTRU may include the ID/index of the selected LCG in the indication. The benefit of the WTRU to dynamically select one or more preconfigured LCGs when handling data associated with PDU sets and/or when sending the indication to base station may be to minimize the overhead signaling and to avoid fragmenting the PDU set during UL transmission, for example.

A WTRU may transmit an indication to a base station, indicating the timing information associated with transmitting one or more PDU sets in UL. In an example, the timing information may be transmitted by the WTRU in a MAC CE and/or an enhanced BSR. The timing information transmitted by the WTRU may include one or more of the following: PDU set delay bound (PSDB) for transmitting one or more PDU sets and/or the remaining delay for transmitting the remaining PDUs of one or more PDU sets. The timing information may be transmitted explicitly (e.g., indicating the index/value of PSDB or remaining delay) or implicitly (e.g., using an LCG/LCH ID or a priority value in the indication that may be associated with the PSDB or remaining delay). In an example, the indication comprising the timing information may be transmitted by the WTRU when requesting for UL resource grant (e.g., in BSR or enhanced BSR) for transmitting a new PDU set. In an example, the indication comprising the timing information (e.g., remaining delay) may be transmitted by the WTRU after transmitting some of the PDUs of one or more PDU sets and/or when the remaining delay for transmitting some of the PDUs of one or more PDU sets is above/below a delay threshold value. In an example, the indication comprising implicit or explicit timing information may be transmitted by the WTRU for updating a previously transmitted request for resource grant (e.g., BSR). For example, the update indication transmitted by the WTRU may indicate any of a request for updated payload size, updated PSDB, and updated remaining delay, and cancellation of previous BSR.

A WTRU may determine an LCP configuration to apply for supporting traffic attributes and QoS of PDU sets. For example, a PDU set may include one or more PDUs that are associated with a (e.g., one) unit of information generated at an application, and are subject to per-PDU set level quality of service (QOS). For example, the WTRU may determine whether to use a first LCP configuration (e.g., an LCP configuration to handle all non-empty LCHs) or a second LCP configuration (e.g., a new LCP configuration to handle only LCHs associated with PDU set) for transmitting a PDU set in UL based on the XR traffic QoS (e.g., PDU set delay bound).

The WTRU may be configured to perform one or more of the following. The WTRU may receive configuration information from a network (e.g., gNB). For example, the configuration information may include a delay threshold associated with one or more PDU sets. The WTRU may receive data consisting of one or more PDU sets from a higher layer. The WTRU may determine the total payload size and delay bound of the one or more PDU sets. If the PDU set delay is less than the delay threshold associated with PDU sets and the total payload size is greater than the payload size threshold, the WTRU may perform one or more actions. If the PDU set delay bound is greater than or equal to the delay threshold associated with PDU sets and/or the total payload size is greater than the payload size threshold, the WTRU may perform one or more actions. If the PDU set delay bound is less than the delay threshold associated with PDU sets and/or total payload size is less than the payload size threshold, the WTRU may perform one or more actions.

The WTRU may receive configuration information from a network (e.g., gNB). For example, the configuration information may include one or more of the following: a first LCP configuration; a second LCP configuration; one or more delay threshold values associated with one or more PDU sets; one or more payload size threshold values associated with one or more PDU sets; and/or LCP restrictions indicating the restricted association between the configured resources (e.g., SR resources, configured grants) and one or more LCHs.

The configuration information may include a first LCP configuration. For example, the first LCP configuration may handle one or more (e.g., all) non-empty LCHs that may contain PDUs in the LCH buffers. The first LCP configuration may correspond to the default LCP configuration that may be used by the WTRU for handling one or more (e.g., all) data/PDU types (e.g., PDU sets, non-PDU sets). The first LCP configuration may be activated and/or used by the WTRU after receiving the configuration information from the network. The first LCP configuration may include a logical channel restriction for the LCHs associated with the PDU set.

The configuration information may include a second LCP configuration. For example, the second LCP configuration may handle (e.g., only) one or more LCHs that are associated with delivery of one or more PDU sets. The second LCP configuration and the LCHs associated with PDU sets may be configured for ensuring the PDU set-level and/or PDU set group-level QoS (e.g., latency, reliability, throughput) are met during UL transmission. The PDU set group may consist of one or more PDU sets that may be inter-dependent with each other (e.g., the inter-dependent PDU sets in the PDU set group may consist of a common PDU set group ID, in the packet headers). The second LCP configuration may include a logical channel restriction for the LCHs associated with the PDU set.

The configuration information may include one or more delay threshold values associated with one or more PDU sets. For example, the delay threshold may be used by the WTRU for determining the LCP configuration to be applied for multiplexing and scheduling the PDUs of the PDU set/PDU set group during UL transmission.

The configuration information may include one or more payload size threshold values associated with one or more PDU sets. For example, the payload size threshold may be used for determining the total payload (e.g., in bits/bytes) of the PDUs in a PDU set and/or inter-dependent PDU sets in a PDU set group.

The WTRU may receive data consisting of one or more PDU sets. For example, the data received may be associated with a single PDU set or multiple PDU sets (e.g., in a PDU set group or data burst) that may be inter-dependent with each other. Different PDUs sets, which may or may-not be interdependent with each other, may arrive at the WTRU at different time instances.

The WTRU may determine the total payload size and PDU delay information associated with a PDU set of the one or more PDU sets (e.g., a delay bound of the one or more PDU sets and/or a remaining amount of delay of the one or more PDU sets). For example, the WTRU may determine the total payload size by summing the of payloads of the inter-dependent one or more PDU sets. The WTRU may determine the delay bound of the PDU sets (e.g., inter-dependent in a PDU set group) based on QoS markings (e.g., QFI, PDU-set QFI, timestamps) in the packet header and preconfigured association info indicating the QoS markings and delay bound. The PDU delay information may comprise a remaining amount of delay associated with (e.g., with respect to) the delay bound of a PDU set. For example, the WTRU may receive the delay bound of the PDU set. The delay bound may be a fixed value that may be indicated to the WTRU based on, for example, the PDU set header. The WTRU may (e.g., dynamically) determine the remaining amount of delay as a difference between the delay bound and a time duration the PDU set spends in a logical channel (e.g., since the PDU set is received from higher layers). For example, the WTRU may determine the remaining amount of delay for a PDU set by subtracting the time duration from the delay bound for the PDU set.

The WTRU may map the PDUs in the PDU set to one or more logical channels. The WTRU may select one or more logical channels for the PDU set, for example based on the PDU delay information (e.g., the PDU set delay bound and/or the remaining amount of delay), the delay threshold, the total payload size of the PDU set, and/or payload size threshold. The WTRU may then determine a logical channel prioritization (LCP) configuration associated with the selected logical channels based on the selected logical channels, the PDU delay information (e.g., the PDU set delay bound and/or the remaining amount of delay), the delay threshold, the total payload size of the PDU set, and/or payload size threshold. For example, the WTRU may compare the delay information to the delay threshold, and/or may compare the total payload size to the payload size threshold.

If the PDU delay information (e.g., the PDU set delay bound and/or the remaining amount of delay) is less than the delay threshold associated with PDU sets and the total payload size is greater than the payload size threshold, the WTRU may perform one or more of the following actions. The WTRU may determine the set of one or more LCHs that may contain data associated with the PDU sets (e.g., PDU sets in a PDU set group that may be inter-dependent). The WTRU may transmit an indication to the gNB (e.g., in a new BSR, MAC CE, and/or UCI). For example, the indication (e.g., in new BSR) may indicate one or more of the following: the delay information (e.g., the delay bound of the PDU set and/or the remaining amount of delay), timing information associated with the one or more PDU sets (e.g., remaining time for transmitting the remaining PDU/PDY sets), total payload size, the set of one or more LCHs (e.g., IDs) that contain data associated with the one or more PDU sets (e.g., inter-dependent), and/or an LCG (LCH group) ID consisting of the group of LCHs that may contain data associated with PDU set group. The WTRU may receive resource grant(s) from the gNB. For example, the resource grants may include one or more dynamic grants (e.g., single slot or multi-slot), and/or configured grants. The WTRU may suspend the use of the default/first LCP configuration for a time duration associated with the delay bound of the PDU sets, and may use the second LCP configuration. For example, the WTRU may suspend the use of the first LCP configuration and use the second LCP configuration if there is no other data in any of the LCHs that have higher priority than the data associated with PDU sets. The WTRU may use the second LCP configuration to multiplex the one or more PDU sets into one or more TBs. For example, the WTRU may prioritize the PDUs of the PDU set(s) over PDUs of a higher-priority LCH. The WTRU may transmit the prioritized plurality of PDUs of the PDU set. For example, the multiplexing of the PDU sets may be done at the MAC entity/sublayer at the WTRU. The second LCP configuration may be used for a time duration associated with the delay bound of the PDU sets. The WTRU may transmit the TBs carrying the one or more PDU sets using resource grant(s) provided by the gNB. The WTRU may resume the first LCP configuration upon transmitting the TBs.

If the PDU delay information (e.g., the PDU set delay bound and/or the remaining amount of delay) is greater than the delay threshold associated with PDU sets and/or the total payload size is greater than the payload size threshold, the WTRU may perform one or more of the following actions. The WTRU may determine to relax the LCP restrictions in one or more LCHs, possibly associated with the handling of non-PDU sets. The WTRU may relax the LCP restrictions for accessing the resource grants associated with the other LCHs (e.g., LCHs handling non-PDU sets). The WTRU may transmit an indication to the gNB (e.g., in new BSR, MAC CE, and/or UCI) indicating relaxation of LCP restrictions. The WTRU may receive resource grant(s) from the gNB. The WTRU may use the first LCP configuration to multiplex the one or more PDU sets into one or more TBs. The WTRU may transmit the PDUs of the PDU set (e.g., TBs carrying the one or more PDU sets) using resource grant(s) from other LCHs and/or any resources provided by the gNB.

If the PDU set delay bound is less than the delay threshold associated with PDU sets and/or total payload size is less than the payload size threshold, the WTRU may perform one or more of the following actions. The WTRU may transmit an indication to the gNB (e.g., in new BSR, MAC CE, and/or UCI). The indication (e.g., in new BSR) may indicate one or more of the following: PDU delay information (e.g., the PDU set delay bound and/or the remaining amount of delay) of the PDU set, timing information associated with the one or more PDU sets (e.g., remaining time for transmitting the remaining PDU/PDY sets), total payload size, the set of one or more LCHs (e.g., IDs) that contain data associated with the one or more PDU sets (e.g., inter-dependent), LCG (LCH group) ID consisting of the group of LCHs that may contain data associated with PDY set group. The WTRU may receive resource grant(s) from the gNB. The WTRU may use the first LCP configuration to multiplex the one or more PDU sets into one or more TBs. The WTRU may transmit the TBs carrying the one or more PDU sets using resources provided by the gNB.

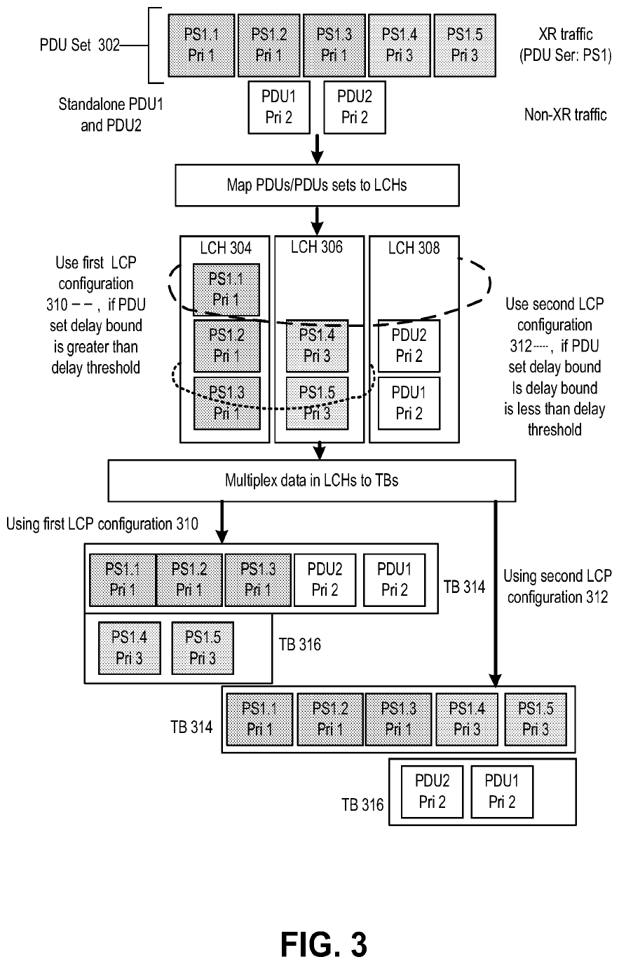

FIG. 3 illustrates an example of a WTRU determining an LCP configuration to apply for supporting traffic attributes and QoS of PDU sets. As shown in FIG. 3, the WTRU may determine whether to use a first LCP configuration (e.g., LCP configuration 310) and/or a second LCP configuration (e.g., LCP configuration 312) for transmitting a PDU set in UL based on the XR traffic QoS (e.g., PDU set delay bound). If a configured QoS condition (e.g. delay threshold) is met, the WTRU may use the second LCP configuration to transmit the PDU set.

For example, as shown in FIG. 3, there may be a PDU set 302 comprising one or more (e.g., 5) PDUs associated with XR traffic, which may be labeled as PS1.1, PS1.2, PS1.3, PS1.4, and PS1.5. One or more of the PDUs in the PDU set 302 may be associated with a first priority (e.g., priority 1, shown as “Pri 1” in FIG. 3), and one or more other PDUs of the PDU set 302 may be associated with a second priority (e.g., priority 3, shown as “Pri 3” in FIG. 3). There may be one or more PDUs (e.g., standalone PDUs) which may be associated with non-XR traffic (e.g., PDU1 and PDU2 shown in FIG. 3). The PDUs associated with non-XR traffic may be associated with a third priority (e.g., priority 2, shown as “Pri 2” in FIG. 3). The third priority may be the same as or different from the first priority and/or the second priority.

The PDUs of the PDU set 302 and/or the standalone PDUs may be mapped to LCHs, for example based on the respective priorities. For example, as shown in FIG. 3, one or more first PDUs associated with the first priority (e.g., PDUs PS1.1, PS1.2, and PS1.3) may be mapped to a first LCH 304, one or more second PDUs associated with the second priority (e.g., PDUs PS1.4 and PS1.5) may be mapped to a second LCH 306, and one or more third PDUs associated with the third priority (e.g., PDUs PDU1 and PDU2) may be mapped to a third LCH 308. The WTRU may determine whether to use a first LCP configuration (e.g., the first LCP configuration 310 shown in FIG. 3) and/or a second LCP configuration (e.g., the first LCP configuration 312 shown in FIG. 3, which may be a new LCP to handle one or more of the logical channels 304, 306, 308) for transmitting the PDUs based on the XR traffic QoS. The WTRU may multiplex data in the LCHs 304, 306, 308 to TBs based on the selected LCP configuration.

If the WTRU selects the first LCP configuration 310, the PDUs may be multiplexed to TBs based on respective priorities of the PDUs. For example, as shown in FIG. 3, if the WTRU selects the first LCP configuration 310, the WTRU may multiplex PS1.1, PS1.2, PS1.3, PDU2, and PDU1 into a first TB 314, and PDUs PS1.4 and PS1.5 into a second TB 316. The WTRU may transmit the first TB 314 and the second TB 316.

If the WTRU selects the second LCP configuration 312, the PDUs may be multiplexed to TBs based on grouping the PDUs of the PDU set 302 together. For example, as shown in FIG. 3, if the WTRU selects the second LCP configuration 312, the WTRU may multiplex the PDUs of the PDU set 302 (e.g., PS1.1, PS1.2, PS1.3, PS1.4, and PS1.5) into the first TB 314, and standalone PDUs PDU1 and PDU2 into the second TB 316. The WTRU may transmit the first TB 314 and the second TB 316.

For example, a WTRU may receive configuration information associated with one or more PDU sets. The configuration information may include a delay threshold. The WTRU may determine PDU delay information (e.g., the PDU set delay bound and/or the remaining amount of delay) associated with a first PDU set of the one or more PDU sets. For example, as described herein, the PDU delay information may comprise a remaining amount of delay associated with a delay bound of the first PDU set. The first PDU set may include a plurality of PDUs. The WTRU may transmit an indication of the PDU delay information to the network.

The WTRU may select one or more LCHs for the first PDU set and/or map the PDUs of the first PDU set to one or more LCHs. The WTRU may determine an LCP configuration associated with the selected logical channels based on the delay threshold and/or the PDU delay information. For example, the WTRU may select a first LCP configuration or a second configuration. An (e.g., each) LCP configuration may include a logical channel restriction for the logical channel(s) associated with the PDU set. The WTRU may compare the delay information to the delay threshold. If the delay information is less than or equal to the delay threshold, the WTRU may select the first LCP configuration. If the delay information is greater than to the delay threshold, the WTRU may select the second LCP configuration.

The WTRU may transmit the PDU set using the determined LCP configuration. For example, transmitting the PDU set using the first LCP configuration may include prioritizing the PDUs of the PDU set over PDUs of a higher-priority logical channel, and transmitting the prioritized PDUs of the PDU set. Transmitting the PDU set using the second LCP configuration may include prioritizing PDUs of one or more logical channels based on a decreasing order of priority associated with the logical channels, and transmitting the prioritized PDUs. An (e.g., each) LCP configuration may comprise one or more LCP parameters for at least one LCH. The LCP parameters may comprise (e.g., indicate) a prioritization of the PDUs of the first PDU set over the PDUs of the higher-priority logical channel (e.g., PDUs of a second PDU set).

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1.-20. (canceled)

21. A wireless transmit/receive unit (WTRU) comprising a processor configured to:
receive, from a network, configuration information comprising a threshold value associated with one or more protocol data unit (PDU) sets;
determine one or more PDU sets to be transmitted, wherein each PDU set of the one or more PDU sets is associated with one or more logical channels (LCHs);
determine a subset of the one or more PDU sets, wherein each PDU set of the subset of the one or more PDU sets is associated with a respective remaining time value that is less than the threshold value;
select a subset of the LCHs, wherein each LCH of the subset of LCHs comprises at least one PDU set of the subset of the one or more PDU sets;
multiplex PDU sets of the selected subset of the LCHs into one or more transport blocks (TBs); and
transmit the TBs.

22. The WTRU of claim 21, wherein the configuration information further comprises a first logical channel prioritization (LCP) configuration and a second LCP configuration, and wherein the processor is further configured to determine whether to use the first LCP configuration or the second LCP configuration for transmitting the one or more PDU sets.

23. The WTRU of claim 21, wherein the threshold value is a delay threshold value.

24. The WTRU of claim 21, wherein the processor is further configured to:
transmit, to the network, an indication associated with the determined subset of the one or more PDU sets; and
receive, from the network, a resource grant.

25. The WTRU of claim 24, wherein the indication associated with the PDU sets is transmitted via one or more of a buffer status report (BSR), a medium access control (MAC) control element (CE), or uplink control information (UCI).

26. The WTRU of claim 24, wherein the resource grant comprises at least one of a dynamic grant (DG) and a configured grant (CG).

27. The WTRU of claim 21, wherein the configuration information further comprises a second threshold value associated with one or more protocol data unit (PDU) sets, wherein the second threshold value comprises a payload size threshold.

28. The WTRU of claim 27, wherein the processor is further configured to:
determine a total payload size of the one or more PDU sets; and
select the subset of the LCHs based on the total payload size of the one or more PDU sets being greater than the payload size threshold.

29. The WTRU of claim 21, wherein the processor being configured to determine the one or more PDU sets to be transmitted comprises the processor being configured to receive the one or more PDU sets from a higher layer.

30. The WTRU of claim 21, wherein the processor being configured to determine a subset of the one or more PDU sets comprises the processor being configured to:
determine, for each PDU set of the one or more PDU sets, a respective remaining time value associated with the PDU set based on respective quality of service (QOS) markings; and
select each PDU set of the one or more PDU sets that has a respective remaining time value that is lower than the threshold value for inclusion in the subset.

31. A method implemented in a wireless transmit/receive unit (WTRU), the method comprising:
receiving, from a network, configuration information comprising a threshold value associated with one or more protocol data unit (PDU) sets;
determining one or more PDU sets to be transmitted, wherein each PDU set of the one or more PDU sets is associated with one or more logical channels (LCHs);
determining a subset of the one or more PDU sets, wherein each PDU set of the subset of the one or more PDU sets is associated with a respective remaining time value that is less than the threshold value;
selecting a subset of the LCHs, wherein each LCH of the subset of LCHs comprises at least one PDU set of the subset of the one or more PDU sets;
multiplexing PDU sets of the selected subset of the LCHs into one or more transport blocks (TBs); and
transmitting the TBs.

32. The method of claim 31, wherein the configuration information further comprises a first logical channel prioritization (LCP) configuration and a second LCP configuration, and wherein the method further comprises determining whether to use the first LCP configuration or the second LCP configuration for transmitting the one or more PDU sets.

33. The method of claim 31, wherein the threshold value is a delay threshold value.

34. The method of claim 31, further comprising:
transmitting, to the network, an indication associated with the determined subset of the one or more PDU sets; and
receiving, from the network, a resource grant.

35. The method of claim 34, wherein the indication associated with the PDU sets is transmitted via one or more of a buffer status report (BSR), a medium access control (MAC) control element (CE), or uplink control information (UCI).

36. The method of claim 34, wherein the resource grant comprises at least one of a dynamic grant (DG) and a configured grant (CG).

37. The method of claim 31, wherein the configuration information further comprises a second threshold value associated with one or more PDU sets, wherein the second threshold value comprises a payload size threshold.

38. The method of claim 37, further comprising:
determining a total payload size of the one or more PDU sets; and
selecting the subset of the LCHs based on the total payload size of the one or more PDU sets being greater than the payload size threshold.

39. The method of claim 31, wherein determining the one or more PDU sets to be transmitted comprises receiving the one or more PDU sets from a higher layer.

40. The method of claim 31, wherein determining a subset of the one or more PDU sets comprises:
determining, for each PDU set of the one or more PDU sets, a respective remaining time value associated with the PDU set based on respective quality of service (QOS) markings; and
selecting each PDU set of the one or more PDU sets that has a respective remaining time value that is lower than the threshold value for inclusion in the subset.
